(19) United States
(12) Patent Application Publication
(10) Pub. No.: US 2025/0375946 A1
(43) Pub. Date: Dec. 11, 2025

(54) METHOD FOR REPAIRING COMPOSITE STRUCTURES FOR IMPROVED ELECTROMAGNETIC EFFECTS (EME) PROTECTION

(71) Applicant: The Boeing Company, Arlington, VA (US)

(72) Inventors: Glory Christine EDWARDS, Edmonds, WA (US); Arne K. LEWIS, Auburn, WA (US); Remmelt Andrew STAAL, Irvine, CA (US)

(73) Assignee: The Boeing Company, Arlington, VA (US)

(21) Appl. No.: 18/959,340

(22) Filed: Nov. 25, 2024

Related U.S. Application Data
(63) Continuation-in-part of application No. 18/736,267, filed on Jun. 6, 2024.

(51) Int. Cl. B29C 73/10

(52) U.S. Cl. CPC B29C 73/10; B29K 2995/0005

(57) ABSTRACT

A method for repairing a composite structure for electromagnetic effects (EME) protection, including identifying a repair area on a composite structure, applying a composite repair patch over the repair area, and applying a conductive layer over the composite repair patch and an area of the composite structure surrounding the composite repair patch, wherein the conductive layer overlaps the composite repair patch, wherein the conductive layer includes a metal or metal alloy, and wherein the conductive layer creates a conductive bridge over the composite repair patch to provide an EME protection to the composite structure and enhance a dispersion of lightning strike energy along the composite structure.

### CROSS-REFERENCE TO RELATED APPLICATIONS

This application is a continuation-in-part of U.S. patent application Ser. No. 18/736,267 filed on Jun. 6, 2024, which is incorporated by reference herein in its entirety.

### TECHNICAL FIELD

The present disclosure generally relates to methods for repairing composite structures. More particularly, the present disclosure relates to methods for repairing composite structures for electromagnetic effects (EME) protection.

### BACKGROUND

Aircraft experience electromagnetic effects (EME) from a variety of sources, such as lightning strikes, which may impact the aircraft and can concentrate at structural joints created by mechanical fasteners. For example, lightning currents may travel through structural joints via the mechanical fasteners and the fuselage skin in contact with the mechanical fasteners may provide the pathways for current mobility. Metallic aircraft structures are readily conductive and, thus, can be less susceptible to EME. However, composite aircraft structures (e.g., carbon fiber reinforced thermoset and thermoplastic composite structures) may have a lower conductivity than traditional aluminum or metallic structures, and poor fiber connectivity to the mechanical fasteners may inhibit current flow and increase current density. Increasing current density may give rise to ignition sources, such as heat and thermal decomposition of surrounding organics, causing hot particle ejection or arcing across poorly connected interfaces. Some composite aircraft structures include characteristics or features for improved electromagnetic effects (EME) protection to help disperse energy from lightning strikes and mitigate potential damage to the aircraft. However, repair of such composite aircraft structures may affect the levels of EME protection. Accordingly, there is a need for methods for repairing composite aircraft structures that provide electromagnetic effects (EME) protection to the repair area.

### BRIEF SUMMARY

This summary is intended merely to introduce a simplified summary of some aspects of one or more implementations of the present disclosure. This summary is not an extensive overview, nor is it intended to identify key or critical elements of the present teachings, nor to delineate the scope of the disclosure. Rather, its purpose is merely to present one or more concepts in simplified form as a prelude to the detailed description below.

The foregoing and/or other aspects and utilities exemplified in the present disclosure may be achieved by providing a method for repairing a composite structure for electromagnetic effects (EME) protection, including identifying a repair area on a composite structure; applying a composite repair patch over the repair area; and applying a conductive layer over the composite repair patch and an area of the composite structure surrounding the composite repair patch, wherein the conductive layer overlaps the composite repair patch, wherein the conductive layer comprises a metal or metal alloy, and wherein the conductive layer creates a conductive bridge over the composite repair patch to provide an EME protection to the composite structure and enhance a dispersion of lightning strike energy along the composite structure.

An exterior surface of the composite structure can include an outer layer, and applying the composite repair patch over the repair area can include applying the composite repair patch to the outer layer over the repair area.

A surfacer layer can be disposed over the outer layer, and applying the composite repair patch over the repair area can include removing a portion of the surfacer layer to expose the outer layer over the repair area.

A base conductive layer can be disposed over at least a portion of the outer layer, and applying the composite repair patch over the repair area can include removing the base conductive layer to expose the outer layer over the repair area and applying the composite repair patch to the exposed outer layer.

A surfacer layer can be disposed over the base conductive layer, and applying the composite repair patch over the repair area can include removing a portion of the surfacer layer to expose the outer layer over the repair area and to expose at least a portion of the base conductive layer corresponding to an overlap area corresponding to the conductive layer.

Applying the conductive layer over the composite repair patch and the area of the composite structure surrounding the composite repair patch can include applying the conductive layer to directly contact the exposed base conductive layer in the overlap area to create a conductive bridge for the base conductive layer over the composite repair patch.

The repair area can include one or more mechanical fasteners, and applying the composite repair patch over the repair area can include removing the one or more mechanical fasteners in the repair area and applying the composite repair patch over one or more filled-in spaces corresponding to the one or more mechanical fasteners removed from the repair area.

Applying the conductive layer over the composite repair patch and the area of the composite structure surrounding the composite repair patch can include disposing one or more mechanical fasteners through the conductive layer and the composite repair patch in the repair area and creating a conductive bridge for the one or more mechanical fasteners over the composite repair patch.

The outer layer can be conductive and can include an inter woven wire fabric (IWWF) layer comprising carbon fibers, and applying the conductive layer over the composite repair patch and the area of the composite structure surrounding the composite repair patch can include applying the conductive layer to directly contact the exposed outer layer in an overlap area corresponding to the conductive layer to create a conductive bridge for the outer layer over the composite repair patch.

The outer layer can be disposed over a middle layer, and the middle layer does not include conductive elements to isolate a dispersion of lightning strike energy to the outer layer.

The foregoing and/or other aspects and utilities exemplified in the present disclosure may also be achieved by providing a method for repairing a composite structure for electromagnetic effects (EME) protection, including identifying a repair area on a composite structure; removing a portion of the composite structure corresponding to the repair area to create a repair cavity; applying a composite scarf repair patch in the repair cavity; and applying a conductive layer over the composite scarf repair patch and an area of the composite structure surrounding the composite scarf repair patch, wherein the conductive layer overlaps the composite scarf repair patch, wherein the conductive layer comprises a metal or metal alloy, and wherein the conductive layer creates a conductive bridge over the composite repair patch to provide an EME protection to the composite structure and to enhance a dispersion of lightning strike energy along the composite structure.

An exterior surface of the composite structure can include an outer layer, and removing the portion of the composite structure corresponding to the repair area to create the repair cavity can include removing a portion of the outer layer to create the repair cavity.

A surfacer layer can be disposed over the outer layer, and removing the portion of the composite structure corresponding to the repair area to create the repair cavity can include removing a portion of the surfacer layer to expose the outer layer corresponding to the repair area.

A base conductive layer can be disposed over at least a portion of the outer layer in the repair area, and removing the portion of the composite structure corresponding to the repair area to create the repair cavity can include removing a portion of the base conductive layer to expose the outer layer in the repair area.

A surfacer layer can be disposed over the base conductive layer, and removing the portion of the composite structure corresponding to the repair area to create the repair cavity can include removing a portion of the surfacer layer to expose the outer layer over the repair area and to expose at least a portion of the base conductive layer corresponding to an overlap area corresponding to the conductive layer.

Applying the conductive layer over the composite scarf repair patch and at least the area of the composite structure surrounding the composite scarf repair patch can include applying the conductive layer to directly contact the base conductive layer in the overlap area to create a conductive bridge for the base conductive layer over the composite scarf repair patch.

The repair area can include one or more mechanical fasteners, and removing the portion of the composite structure corresponding to the repair area to create the repair cavity can include removing the one or more mechanical fasteners in the repair area.

Applying the conductive layer over the composite scarf repair patch and at least the area of the composite structure surrounding the composite scarf repair patch can include disposing one or more mechanical fasteners through the conductive layer and the composite scarf repair patch in the repair area and creating a conductive bridge for the one or more mechanical fasteners over the composite scarf repair patch.

The outer layer can be conductive and can include an inter woven wire fabric (IWWF) layer comprising carbon fibers, and applying the conductive layer over the composite scarf repair patch and at least the area of the composite structure surrounding the composite scarf repair patch can include applying the conductive layer to directly contact at least a portion of the outer layer surrounding the composite scarf repair patch to create a conductive bridge for the outer layer over the composite scarf repair patch.

The foregoing and/or other aspects and utilities exemplified in the present disclosure may also be achieved by providing a repair patch for electromagnetic effects (EME) protection of composite structures, including a composite repair patch or a composite scarf repair patch sized to correspond to a repair area of a composite structure; and a conductive layer disposed on the composite repair patch or the composite scarf repair patch, wherein the conductive layer has a size larger than the composite repair patch or the composite scarf repair patch, wherein the conductive layer is configured to overlap the composite repair patch or a composite scarf repair patch when disposed on the composite structure, and wherein the conductive layer comprises a metal or metal alloy and the conductive layer is configured to create a conductive bridge over the composite repair patch or the composite scarf repair patch.

Further areas of applicability will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The accompanying drawings, which are incorporated in, and constitute a part of this specification, illustrate implementations of the present teachings and, together with the description, serve to explain the principles of the disclosure. In the figures:

FIG. 1 illustrates a method for repairing a composite structure for electromagnetic effects (EME) protection according to an implementation of the present disclosure.

FIG. 2 illustrates a composite structure repair according to an implementation of the method illustrated in FIG. 1.

FIG. 3 illustrates a composite structure repair according to an implementation of the method illustrated in FIG. 1.

FIG. 4 illustrates a composite structure repair according to an implementation of the method illustrated in FIG. 1.

FIG. 5 illustrates a composite structure repair according to an implementation of the method illustrated in FIG. 1.

FIG. 6 illustrates a composite structure repair according to an implementation of the method illustrated in FIG. 1.

FIG. 7 illustrates a composite structure repair according to an implementation of the method illustrated in FIG. 1.

FIG. 8 illustrates a composite structure repair according to an implementation of the method illustrated in FIG. 1.

FIG. 9 illustrates a composite structure repair according to an implementation of the method illustrated in FIG. 1.

FIG. 10 illustrates a composite structure repair according to an implementation of the method illustrated in FIG. 1.

FIG. 11 illustrates a method for repairing a composite structure for electromagnetic effects (EME) protection according to an implementation of the present disclosure.

FIG. 12 illustrates a composite structure repair according to an implementation of the method illustrated in FIG. 11.

FIG. 13 illustrates a composite structure repair according to an implementation of the method illustrated in FIG. 11.

FIG. 14 illustrates a composite structure repair according to an implementation of the method illustrated in FIG. 11.

FIG. 15 illustrates a composite structure repair according to an implementation of the method illustrated in FIG. 11.

FIG. 16 illustrates a composite structure repair according to an implementation of the method illustrated in FIG. 11.

FIG. 17 illustrates a composite structure repair according to an implementation of the method illustrated in FIG. 11.

FIG. 18 illustrates a composite structure repair according to an implementation of the method illustrated in FIG. 11.

FIG. 19 illustrates a composite structure repair according to an implementation of the method illustrated in FIG. 11.

FIG. 20 illustrates a flow diagram of aircraft production and service methodology.

FIG. 21 illustrates a block diagram of an aircraft.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary implementations of the present teachings, examples of which are illustrated in the accompanying drawings. Generally, the same reference numbers will be used throughout the drawings to refer to the same or like parts.

Throughout the specification and claims, the following terms take the meanings explicitly associated herein, unless the context clearly dictates otherwise. Phrases, such as, “in an implementation,” “in certain implementations,” and “in some implementations” as used herein do not necessarily refer to the same implementation(s), though they may. Furthermore, the phrases “in another implementation” and “in some other implementations” as used herein do not necessarily refer to a different implementation, although they may. As described below, various implementations can be readily combined, without departing from the scope or spirit of the present disclosure.

As used herein, the term “or” is an inclusive operator, and is equivalent to the term “and/or,” unless the context clearly dictates otherwise. The term “based on” is not exclusive and allows for being based on additional factors not described unless the context clearly dictates otherwise. In the specification, the recitation of “at least one of A, B, and C,” includes implementations containing A, B, or C, multiple examples of A, B, or C, or combinations of A/B, A/C, B/C, A/B/B/, B/B/C, A/B/C, etc. In addition, throughout the specification, the meaning of “a,” “an,” and “the” include plural references. The meaning of “in” includes “in” and “on.” Similarly, implementations of the present disclosure may suitably comprise, consist of, or consist essentially of, the elements A, B, C, etc.

It will also be understood that, although the terms first, second, etc. can be used herein to describe various elements, these elements should not be limited by these terms. These terms are only used to distinguish one element from another. For example, a first object, component, or step could be termed a second object, component, or step, and, similarly, a second object, component, or step could be termed a first object, component, or step, without departing from the scope of the invention. The first object, component, or step, and the second object, component, or step, are both, objects, component, or steps, respectively, but they are not to be considered the same object, component, or step. It will be further understood that the terms “includes,” “including,” “comprises” and/or “comprising,” when used in this specification, specify the presence of stated features, steps, operations, elements, and/or components, but do not preclude the presence or addition of one or more other features, steps, operations, elements, components, and/or groups thereof. Further, as used herein, the term “if” can be construed to mean “when” or “upon” or “in response to determining” or “in response to detecting,” depending on the context.

All physical properties that are defined hereinafter are measured at 20° C. to 25° C. (68° F. to 77° F.) unless otherwise specified.

When referring to any numerical range of values herein, such ranges are understood to include each and every number and/or fraction between the stated range minimum and maximum, as well as the endpoints. For example, a range of 0.5% to 6% would expressly include all intermediate values of, for example, 0.6%, 0.7%, and 0.9%, all the way up to and including 5.95%, 5.97%, and 5.99%, among many others. The same applies to each other numerical property and/or elemental range set forth herein, unless the context clearly dictates otherwise.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges. The terms “about” or “substantial” and “substantially” or “approximately,” with reference to amounts or measurement values, are meant that the recited characteristic, parameter, or values need not be achieved exactly. Rather, deviations or variations, including, for example, tolerances, measurement error, measurement accuracy limitations, and other factors known to those skilled in the art, may occur in amounts that do not preclude the effect that the characteristic was intended to provide. As used herein, “about” is to mean within +/−10% of a stated target value, maximum, or minimum value.

Unless otherwise specified, all percentages and amounts expressed herein and elsewhere in the specification should be understood to refer to percentages by weight. The percentages and amounts given are based on the active weight of the material. For example, for an active ingredient provided as a solution, the amounts given are based on the amount of the active ingredient without the amount of solvent or may be determined by weight loss after evaporation of the solvent.

With regard to procedures, methods, techniques, and workflows that are in accordance with some implementations, some operations in the procedures, methods, techniques, and workflows disclosed herein can be combined and/or the order of some operations can be changed.

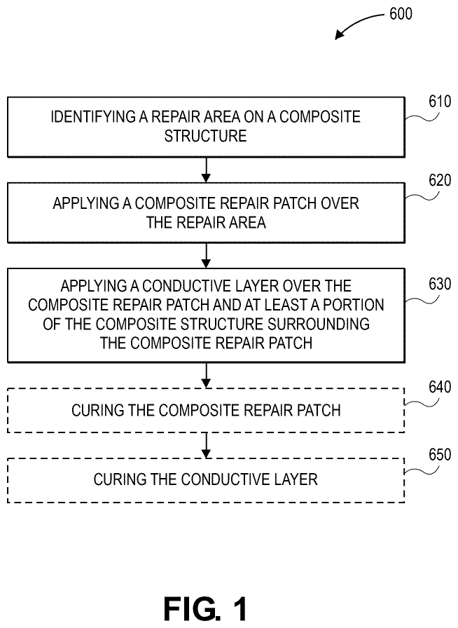

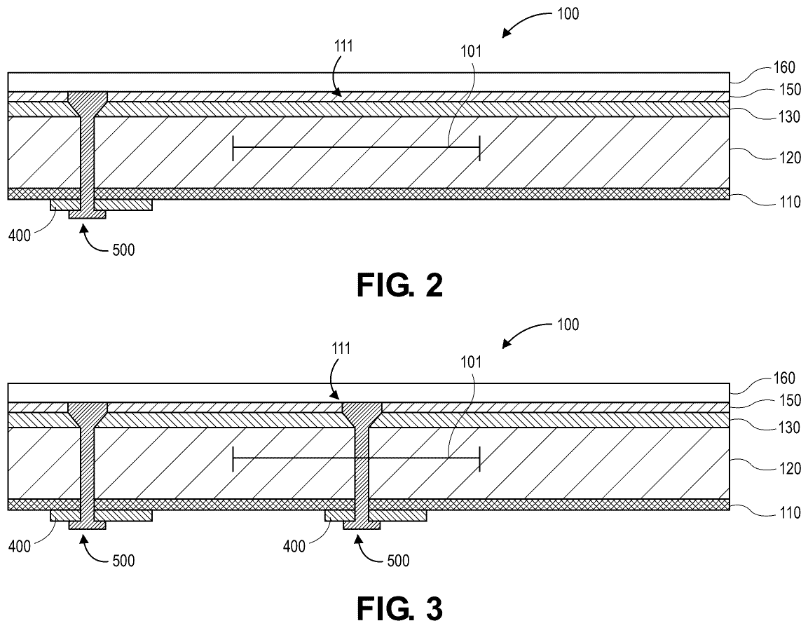

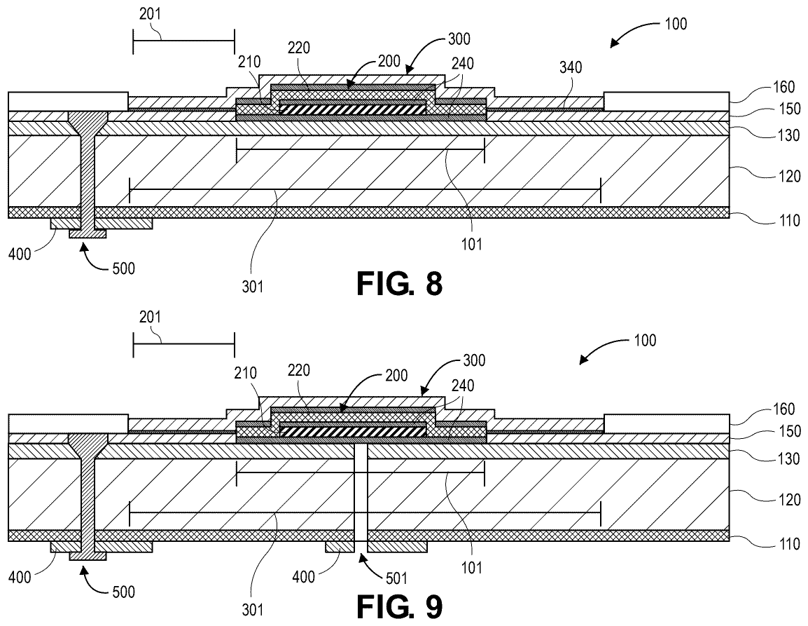

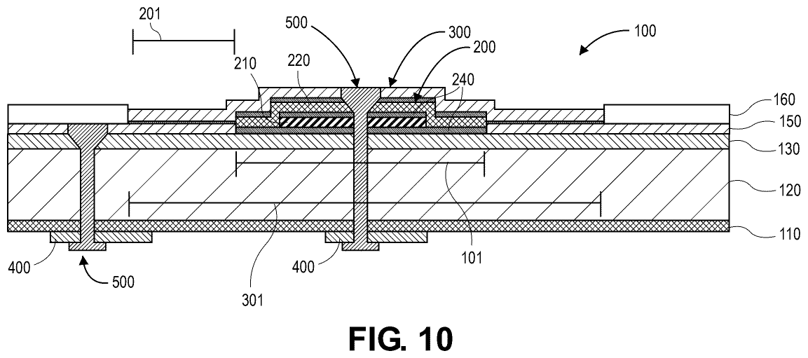

FIG. 1 illustrates a method for repairing a composite structure for electromagnetic effects (EME) protection according to an implementation of the present disclosure. FIGS. 2-10 illustrate a composite structure repair according to implementations of the method illustrated in FIG. 1.

As illustrated in FIGS. 1-10, a method 600 for repairing a composite structure 100 for electromagnetic effects (EME) protection can include identifying a repair area 101 on a composite structure 100 in operation 610, applying a composite repair patch 200 over the repair area 101 in operation 620, and applying a conductive layer 300 over the composite repair patch 200 and a portion of the composite structure 100 surrounding the composite repair patch 200 in operation 630. The conductive layer 300 can cover a larger area than the composite repair patch 200. Accordingly, when disposed over the composite repair patch 200, the conductive layer 300 can overlap the composite repair patch 200 by from about 0.5 inches to about 10 inches. The conductive layer 300 can include a metal or metal alloy, and the conductive layer 300 can create a conductive bridge over the composite repair patch 200 to provide an EME protection of the composite structure 100. For example, the conductive layer 300 can enhance a dispersion of lightning strike energy along the composite structure 100. In some implementations, the method 600 further includes curing the composite repair patch 200 in operation 640 and curing the conductive layer 300 in operation 650.

As illustrated in FIGS. 1-3, the method 600 for repairing a composite structure for EME protection can begin with identifying a repair area 101 on a composite structure 100 in operation 610.

The composite structure 100 can be a composite aircraft structure. For example, the composite structure 100 can comprise a composite fuselage section for an aircraft, such as a barrel-shape composite fuselage section, a half-barrel or semi-circular cross-sectional shape composite fuselage section, or a quarter-barrel shape composite fuselage section. In some implementations, the composite structure 100 can be a composite fuselage panel. In other implementations, the composite structure 100 can include a wing or tail section of an aircraft, or can comprise at least a portion of a composite outer skin of an aircraft.

The composite structure 100 can include carbon fiber reinforced plastic (CFRP) structures, carbon fiber reinforced thermoset structures, and thermoplastic composite structures. For example, the composite structure 100 can comprise one or more composite materials, such as, one or more laminated plies of a fiber reinforced resin. In one implementation, the composite structure 100 comprises a combination of epoxy resin and carbon fibers. In other implementations, the composite structure 100 comprises one or more layers of a carbon fiber reinforced thermoset or thermoplastic. In yet other implementations, the composite structure 100 can comprises one or more fiberglass layers.

As illustrated in FIGS. 2-10, in some implementations the composite structure 100 can comprise two or more layers of composite materials. For example, the composite structure 100 can comprise an inner layer 110, a middle layer 120, and an outer layer 130. The composite structure 100 can further comprise one or more adhesive layers 140 (not illustrated) to bond the inner layer 110, the middle layer 120, and the outer layer 130. In other implementations, the two or more layers of the composite structure 100 can be cured or fusion bonded together without the use of an adhesive layer and/or can be pre-impregnated materials not needing additional adhesives.

The inner layer 110 can define an inner surface of the composite structure 100. The inner layer 110 can constitute an inner mold line for the composite structure 100. The inner layer 110 can comprise one or more composite materials. For example, the inner layer 110 can comprise a plain weave fabric (PW). In some implementations, the inner layer 110 comprises a single composite ply.

The middle layer 120 can be disposed over the inner layer 110. The middle layer 120 can comprise a composite material and the middle layer 120 can comprise a main portion of the composite structure 100.

The middle layer 120 can comprise one or more laminated plies of a fiber reinforced resin, such as a combination of epoxy resin and carbon fiber. In some implementations, the middle layer 120 comprises one or more layers of a carbon fiber reinforced thermoset or thermoplastic. In some implementations, the middle layer 120 does not include conductive elements. For example, the middle layer 120 can exclude inter woven wire fabric (IWWF) layers and/or IWWF layers comprising carbon fibers or the like. Excluding conductive elements from the middle layer 120 can help reduce a total weight of the composite structure 100.

In some implementations, the middle layer 120 focuses EME protection to the outer layer 130 and/or an exterior surface of the composite structure 100. For example, the middle layer 120 can isolate the dispersion of lightning strike energy to the outer layer 130 and/or an exterior surface of the composite structure 100. In some implementations, the middle layer 120 constitutes the inner mold line for the composite structure 100.

The outer layer 130 can be disposed over the middle layer 120. The outer layer 130 can constitute the outer mold line for the composite structure 100 and the outer layer 130 can comprise an exterior surface of the composite structure 100. For example, an exterior surface of the composite structure 100 can comprise the outer layer 130 disposed over the middle layer 120. The outer layer 130 can comprise one or more laminated plies of a fiber reinforced resin, such as a combination of epoxy resin and carbon fiber. In some implementations, the outer layer 130 comprises one or more layers of a carbon fiber reinforced thermoset or thermoplastic. In some implementations, the outer layer 130 can be conductive. For example, the outer layer 130 can include one or more conductive elements or layers, and the outer layer 130 can comprise an inter woven wire fabric (IWWF) layer and/or an IWWF layer comprising carbon fibers. In one implementation, the outer layer 130 can comprise an exterior surface of the composite structure 100, and the outer layer 130 can comprise an IWWF layer comprising carbon fibers.

In other implementations, the outer layer 130 is not conductive and does not include conductive elements. For example, the outer layer 130 can exclude an IWWF layer and/or carbon fibers, and the outer layer 130 can comprise similar materials as the middle layer 120. In one implementation, the outer layer 130 can comprise an exterior surface of the composite structure 100, and the outer layer 130 does not include conductive elements, such as an IWWF layer and/or carbon fibers.

The one or more adhesive layers 140 can comprise materials configured to bond composite materials. For example, the one or more adhesive layers 140 can comprise thermosetting materials, film adhesives, and/or structural film adhesives, such as a pre-cured thermoset material or a thermoplastic material, such as a pressure-sensitive or heat-activated adhesive. The one or more adhesive layers 140 can bond the inner layer 110, the middle layer 120, and the outer layer 130 together to form the composite structure 100.

The one or more adhesive layers 140 can comprise adhesive materials, such as epoxy. For example, the one or more adhesive layers 140 can also comprise an epoxy film adhesive, such as AF555 from the 3M Company or MB1515 from Cytec Engineered Materials, particularly suited for use with composite materials.

As described above, the composite structure 100 can be an aircraft component. Accordingly, in some implementations, the composite structure 100 can be attached to an internal framework 400 of the aircraft using fastening, bonding, adhesives, or other methods and techniques. For example, as illustrated in FIGS. 2-10, one or more mechanical fasteners 500 can be used to attach components of the internal framework 400 to the composite structure 100.

The internal framework 400 can help support the composite structure 100. For example, the internal framework 400 can include a plurality of components configured to reinforce the aircraft fuselage, reinforce the composite structure 100, and help distribute loads and dynamic forces for the composite structure 100 and the aircraft in general. For example, the internal framework 400 can include a plurality of frames or stringers to support and provide rigidity to the composite structure 100 and/or the aircraft in general. The internal framework 400 can also include a plurality of floor beams and stanchions to support a floor, such as a cabin floor. The internal framework 400 can also include a plurality of intercostals and fittings.

The internal framework 400 can include metal, metal alloys, and/or composite materials. In some implementations, the components of the internal framework 400 comprise a mixture of metal, metal alloys, and composite materials. In one implementation, the internal framework 400 comprises a conductive material.

As illustrated in FIGS. 2-10, the internal framework 400 can be joined to composite structure 100 using one or more mechanical fasteners 500. The one or more mechanical fasteners 500 can include bolts, rivets, one-sided and two-sided lockbolts, screws, hex drive bolts, blind fasteners, and the like.

In some implementations, the one or more mechanical fasteners 500 comprise a conductive material. For example, the one or more mechanical fasteners 500 can comprise a metal or metal alloy, such as titanium, corrosion-resistant steel, Inconel, and alloys or combinations thereof.

The one or more mechanical fasteners 500 can be disposed through the composite structure 100. For example, the one or more mechanical fasteners 500 can be disposed through the inner layer 110, the middle layer 120, and the outer layer 130 of the composite structure 100. As described below, in some implementations, a base conductive layer 150 is disposed over the composite structure 100, and the one or more mechanical fasteners 500 can be disposed through the base conductive layer 150 and the composite structure 100. In other implementations, one or more outer protection layers or coatings, such as a surfacer layer 160, can be disposed over an exterior surface of the composite structure 100, and the one or more mechanical fasteners 500 can be disposed through the surfacer layer 160.

As illustrated in FIGS. 2-10, in some implementations, a base conductive layer 150 can be disposed over at least a portion of the composite structure 100. The base conductive layer 150 can be disposed over at least a portion of the repair area 101. For example, the base conductive layer 150 can be disposed over at least a portion of the outer layer 130 in the repair area 101.

The base conductive layer 150 can provide an EME protection to the composite structure 100. For example, the base conductive layer 150 can reduce an energy density of a lightning strike flowing across the composite structure 100. The base conductive layer 150 can be disposed over the outer layer 130. In some implementations, the base conductive layer 150 is not disposed over the entire outer layer 130. For example, to limit a weight added to the aircraft fuselage by the base conductive layer 150, the base conductive layer 150 can avoid being a continuous layer covering an entire exterior surface of the outer layer 130. Instead, the base conductive layer 150 can comprise one or more bands or segments disposed over the outer layer 130. In other implementations, the base conductive layer 150 can be disposed over areas including areas surrounding the one or more mechanical fasteners 500 and/or the base conductive layer 150 can be disposed only in areas of the outer layer 130 surrounding the one or more mechanical fasteners 500. In some implementations, the base conductive layer 150 can be combined with the outer layer 130 to form a single layer.

The base conductive layer 150 can be electrically connected to the outer layer 130. For example, in some implementations, the outer layer 130 and the base conductive layer 150 can be co-cured during a manufacturing process to ensure that at least some of the carbon fibers in the IWWF layer are in direct physical contact with the base conductive layer 150. The base conductive layer 150 and the outer layer 130 can define one or more conductive pathways to reduce an energy density of a lightning strike flowing across the composite structure 100. For example, the base conductive layer 150 can help disperse the energy of a lightning strike along the outer layer 130 or an outer portion of the composite structure 100.

The base conductive layer 150 can be configured to surround at least one of the one or more mechanical fasteners 500. For example, the base conductive layer 150 can cover an area surrounding each of the one or more mechanical fasteners 500 disposed through the outer layer 130, either individually or a group. For example, the base conductive layer 150 can cover a surface area from about 0.5 inches to about 10 inches surrounding the one or more mechanical fasteners 500. The base conductive layer 150 can cover a surface area from about 3.0 inches to about 6.0 inches surrounding the one or more mechanical fasteners 500. In other implementations, the base conductive layer 150 covers at least 1 inch of area surrounding the one or more mechanical fasteners 500 disposed through the outer layer 130. In other implementations, the base conductive layer 150 covers at least 2 inches, at least 3 inches, at least 4 inches, or at least 5 inches of area surrounding the one or more mechanical fasteners 500 disposed through the outer layer 130.

The base conductive layer 150 can comprise a metal or metal alloy. For example, the base conductive layer 150 can comprise copper, aluminum, titanium, nickel, bronze, gold, silver, or alloys thereof. In one implementation, the base conductive layer 150 comprises copper or a copper alloy. The base conductive layer 150 can comprise a single ply of conductive material, such as a metal or metal alloy, or can comprise one or more layers of conductive material.

The base conductive layer 150 comprise an expanded metal foil. In some implementations, the base conductive layer 150 comprises a perforated layer, such as a conductive mesh or perforated foil. For example, the base conductive layer 150 can comprise a perforated copper foil. The base conductive layer 150 can be perforated to decrease an overall weight of the base conductive layer 150. The size of the perforations in the base conductive layer 150 can correspond to a diameter of the one or more mechanical fasteners 500. For example, the size of the perforations in the base conductive layer 150 can be slightly smaller than the diameter of the one or more mechanical fasteners 500 to enhance an electrical connection between the base conductive layer 150 and the one or more mechanical fasteners 500. In other implementations, the base conductive layer 150 is not perforated and through-holes to accommodate the one or more mechanical fasteners 500 are made into the base conductive layer 150 via drilling or during the installation of the one or more mechanical fasteners 500. In yet other implementations the size of the perforations in the base conductive layer 150 are smaller than a diameter of the one or more mechanical fasteners 500, and the one or more mechanical fasteners 500 enlarge said perforations or pierce through the base conductive layer 150 during installation.

The base conductive layer 150 can have a thickness of from about 0.005 inches (5 mil) to about 0.020 inches (20 mil). For example, the base conductive layer 150 can have an average thickness of from about 0.005 inches (5 mil) to about 0.015 inches (15 mil), from about 0.005 inches (5 mil) to about 0.010 inches (10 mil); from about 0.010 inches (10 mil) to about 0.015 inches (15 mil), or from about 0.015 inches (15 mil) to about 0.020 inches (20 mil). If less than 5 mil, the base conductive layer 150 may be too delicate for application in industrial settings and may not provide sufficient EME protection in terms of robustness, durability, and likelihood of flash-offs during an application lifetime.

In some implementations, one or more outer protection layers or coatings, such as a surfacer layer 160, can be disposed over an exterior surface of the composite structure 100. For example, one or more outer protection layers or coatings can be disposed over the outer layer 130 and/or over a base conductive layer 150 disposed over the outer layer 130.

Accordingly, in one implementation, a surfacer layer 160 is disposed over an exterior surface of the composite structure 100 and/or a base conductive layer 150 disposed over the composite structure 100.

The surfacer layer 160 can comprise a coating or surface for the priming and painting of the composite structure 100. The surfacer layer 160 can provide a layer that can be sanded during the finishing of the composite structure 100 to feather or smooth the outer layer 130, or the surfacer layer 160 can be configured to receive further finishing layers, such as pin hole fillers, primers, and paint topcoats. In some implementations, the surfacer layer 160 can be configured to act as an outer protection coating for the composite structure 100 and/or a base conductive layer 150 disposed over the composite structure 100. For example, the surfacer layer 160 can be configured to protect the composite structure 100 from ultraviolet radiation, scuffs and small impacts, liquid penetration, and the like.

In other implementations, the surfacer layer 160 can provide a non-porous and/or nearly impervious exterior surface for the composite structure 100. For example, the surfacer layer 160 can comprise an epoxy-based co-curing agent, such as Cytec's Surface Master® 905.

The repair area 101 can correspond to damage found in the composite structure 100. For example, as illustrated in FIGS. 2-10, a repair area 101 can comprise an area surrounding a damage area 111. The damaged area 111 can be determined by visual inspection or via nondestructive evaluation (NDE) techniques, such as impedance testing, x-ray radiography, thermography, and ultrasonics. In other implementations, the repair area 101 corresponds to areas of the composite structure 100 where EME protection is desired.

In some implementations, the damaged area 111 can affect one or more layers of the composite structure 100. For example, the damaged area 111 can include damage to the inner layer 110, the middle layer 120, and the outer layer 130. The damaged area 111 can also include damage to the base conductive layer 150 and/or the surfacer layer 160.

The repair area 101 can define an area from about 1.0 inch to about 5.0 feet or greater surrounding the damage area 111. In some implementations, the repair area 101 corresponds to a size of the composite repair patch 200, and the composite repair patch 200 can cover an area from about 1.0 inch to about 5.0 feet or greater.

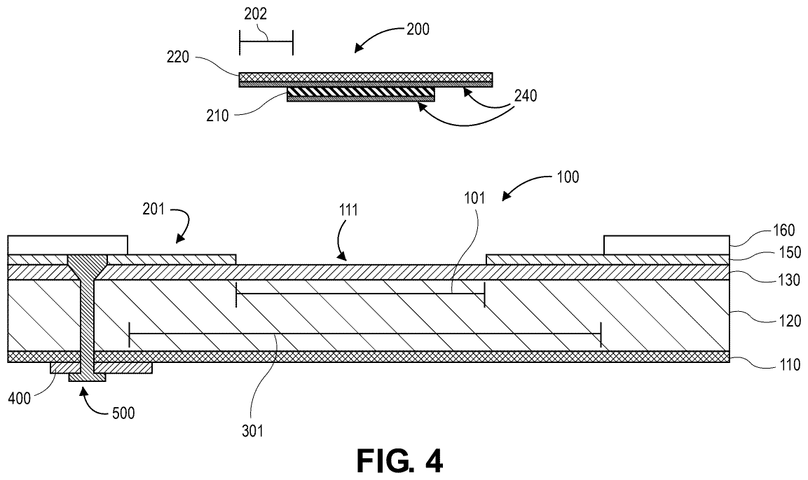

Accordingly, as illustrated in FIGS. 2-10, the repair area 101 can correspond to an area covered by the composite repair patch 200. To ensure overlap by the conductive layer 300, the repair area 101 can be smaller than an area covered by the conductive layer 300. For example, as illustrated in FIGS. 4-10, the repair area 101 can be smaller than an overlap area 301 corresponding to the conductive layer 300.

As illustrated in FIG. 3, in some implementations, the repair area 101 and/or the damage area 111 includes one or more mechanical fasteners 500. For example, the damage area 111 can include a portion of the composite structure 100 surrounding one or more mechanical fasteners 500 or the damage area 111 can include the one or more mechanical fasteners 500 themselves, for example, in case of a damaged fastener or in cases where EME protection is needed around a mechanical fastener, the repair area 101 can surround the one or more mechanical fasteners 500. Accordingly, the repair area 101 can surround one or more mechanical fasteners 500. In some implementations, one or more mechanical fasteners 500 are centered in the repair area 101. In other implementations, the repair area 101 includes an area from about 0.5 inches to about 10 inches surrounding one or more mechanical fasteners 500.

Operation 620 includes applying a composite repair patch 200 over the repair area 101. The composite repair patch 200 can be configured to be compatible with the composite structure 100. Accordingly, the composite repair patch 200 can also include CFRP structures, carbon fiber reinforced thermoset structures, and thermoplastic composite structures. For example, the composite repair patch 200 can comprise one or more composite materials, such as, one or more laminated plies of a fiber reinforced resin and/or a combination of epoxy resin and carbon fibers. In other implementations, the composite repair patch 200 comprises one or more layers of a carbon fiber reinforced thermoset or thermoplastic.

The composite repair patch 200 can comprise the same or similar materials as the composite structure 100. For example, the composite repair patch 200 can comprise the same or similar materials as the middle layer 120 and/or the composite repair patch 200 can comprise the same or similar materials as the outer layer 130.

In some implementations, the composite repair patch 200 does not include conductive elements. For example, in some implementations, the composite repair patch 200 does not include IWWF layers, IWWF layers comprising carbon fibers, and/or carbon fibers.

In some implementations, the composite repair patch 200 is dielectric. For example, the composite repair patch 200 can help isolate the dispersion of lightning strike energy to the outer layer 130 and/or an exterior surface of the composite structure 100 when the composite repair patch 200 is disposed on the composite structure 100.

In some implementations, the composite repair patch 200 can be conductive. For example, the composite repair patch 200 can include one or more conductive elements or layers. The composite repair patch 200 can comprise an IWWF layer, an IWWF layer comprising carbon fibers, carbon fibers, and the like.

As illustrated in FIGS. 2-10, in some implementations the composite repair patch 200 can comprise two or more layers. For example, the composite structure 100 can comprise a bottom layer 210 and a top layer 220. The top layer 220 can be disposed over the bottom layer 210. The composite structure 100 can further comprise one or more adhesive layers 240 to bond the bottom layer 210 and the top layer 220, and/or to bond the composite repair patch 200 to the composite structure 100. In other implementations, the two or more layers of the composite repair patch 200 can be cured or fusion bonded together without the use of an adhesive layer and the one or more adhesive layers 240 just bond the composite repair patch 200 to the composite structure 100.

The bottom layer 210 can be configured to be disposed over an exterior surface of the composite structure 100. For example, the bottom layer 210 can be configured to be disposed over the outer layer 130. The bottom layer 210 can comprise a composite material. For example, the bottom layer 210 can comprise one or more laminated plies of a fiber reinforced resin, such as a combination of epoxy resin and carbon fiber. In some implementations, the bottom layer 210 comprises one or more layers of a carbon fiber reinforced thermoset or thermoplastic. In some implementations, the bottom layer 210 does not include conductive elements. For example, the bottom layer 210 can exclude IWWF layers, IWWF layers comprising carbon fibers, and/or carbon fibers. In other implementations, the bottom layer 210 can be conductive. For example, the bottom layer 210 can include one or more conductive elements or layers. For example, the bottom layer 210 can comprise IWWF layers, IWWF layers comprising carbon fibers, carbon fibers and/or the like.

In some implementations, the bottom layer 210 comprises similar materials as an exterior surface of the composite structure 100. For example, the bottom layer 210 can be configured to have similar materials as the outer layer 130. In one implementation, if the outer layer 130 comprises conductive elements, such as an IWWF layer, the bottom layer 210 can also comprise conductive elements, such as an IWWF layer, an IWWF layer comprising carbon fibers, carbon fibers, and/or the like.

In other implementations, the composite repair patch 200 is non-conductive regardless of the material in an exterior surface of the composite structure 100. For example, if the outer layer 130 comprises conductive elements, such as an IWWF layer, the bottom layer 210 can specifically exclude conductive elements, such as an IWWF layer, an IWWF layer comprising carbon fibers, carbon fibers, and/or the like.

The top layer 220 can be disposed over the bottom layer 210. The top layer 220 can comprise an exterior surface of the composite repair patch 200. The top layer 220 can comprise one or more composite materials. For example, top layer 220 can comprise a plain weave fabric (PW).

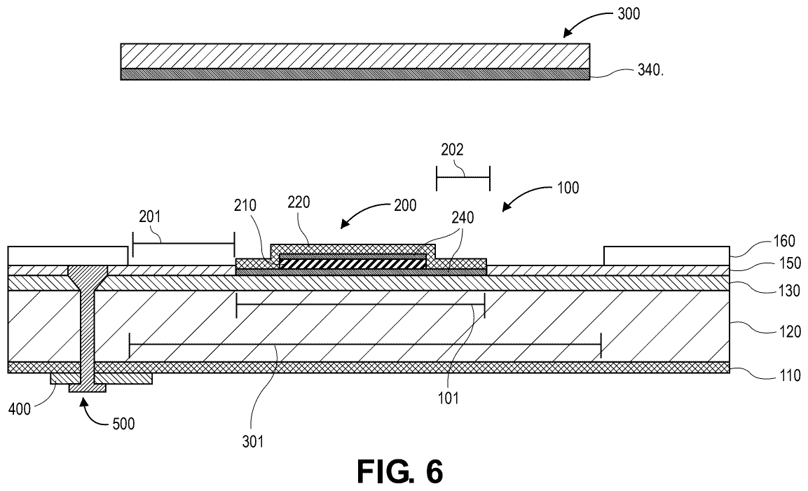

The composite repair patch 200 can be sized to cover the repair area 101. The composite repair patch 200 can have a size from about 1.0 inch to about 5 feet or greater. For example, at least one of the top layer 220 and the bottom layer 210 can have a size corresponding to a size of the repair area 101. In some implementations, a size of the top layer 220 corresponds to a size of the repair area 101 and the bottom layer 210 has a size smaller than the repair area 101. For example, the bottom layer 210 can be sized only to cover the damage area 111 and/or an area immediately surrounding the damage area 111 that is smaller than the repair area 101. As illustrated in FIGS. 6-10, in some implementations, the composite repair patch 200 is smaller than a size of the overlap area 301 and/or a size of the conductive layer 300, and the top layer 220 and the bottom layer 210 have a size smaller than the size of the overlap area 301 and the size of the conductive layer 300.

In some implementations, the top layer 220 is larger than the bottom layer 210. For example, as illustrated in FIGS. 4-7, the top layer 220 can define an overhang area 202 over the bottom layer 210. Accordingly, when disposed over the outer layer 130, the top layer 220 can bond directly to the composite structure 100 and/or the portion of the exposed outer layer 130 in the overhang area 202. However, in other implementations, such as those using pre-cured layers in the composite repair patch 200, the bottom layer 210 may be larger or the same size as the top layer 220.

The one or more adhesive layers 240 can comprise materials configured to bond composite materials. The one or more adhesive layers 240 can comprise materials similar to the one or more adhesive layers 140. For example, the one or more adhesive layers 240 can comprise thermosetting materials, film adhesives, and/or structural film adhesives, such as a pre-cured thermoset material or a thermoplastic material, such as a pressure-sensitive or heat-activated adhesive. The one or more adhesive layers 140 can comprise adhesive materials, such as epoxy. For example, the one or more adhesive layers 240 can also comprise an epoxy film adhesive, such as AF555 from the 3M Company or MB1515 from Cytec Engineered Materials, particularly suited for use with composite materials.

In one implementation, the one or more adhesive layers 240 can be configured to bond the composite repair patch 200 to the composite structure 100. For example, the one or more adhesive layers 240 can permanently bond the composite repair patch 200 to the composite structure 100. In some implementations, the one or more adhesive layers 240 are cured to bond the composite repair patch 200 to the composite structure 100. For example, the one or more adhesive layers 240 require application of a heat or pressure to bond the composite repair patch 200 to the composite structure 100.

As described above, the exterior surface of the composite structure 100 can comprise the outer layer 130. Accordingly, applying the composite repair patch 200 over the repair area 101 can include applying the composite repair patch 200 to the outer layer 130 over the repair area 101.

As described above, in some implementations, a base conductive layer 150 is disposed over the composite structure 100. For example, as illustrated in FIG. 2-5, a base conductive layer 150 can be disposed over at least a portion of the outer layer 130 and/or the exterior surface of the composite structure 100. Accordingly, applying the composite repair patch 200 over the repair area 101 can comprise removing the base conductive layer 150 to expose the outer layer 130 over the repair area 101. The portion of the base conductive layer 150 removed can correspond to a size of the repair area 101 and/or a size of the composite repair patch 200 and the portion of exposed outer layer 130 can correspond to the size of the repair area 101 and/or the size of the composite repair patch 200. In some implementations, the portion of the base conductive layer 150 removed is smaller than a size of the overlap area 301 and/or a size of the conductive layer 300, and the portion of exposed outer layer 130 is smaller than the size of the overlap area 301 and/or the size of the conductive layer 300.

As described above, in some implementations, a surfacer layer 160 is disposed over the base conductive layer 150 and/or the composite structure 100. For example, a surfacer layer 160 can be disposed over the base conductive layer 150 and/or the outer layer 130.

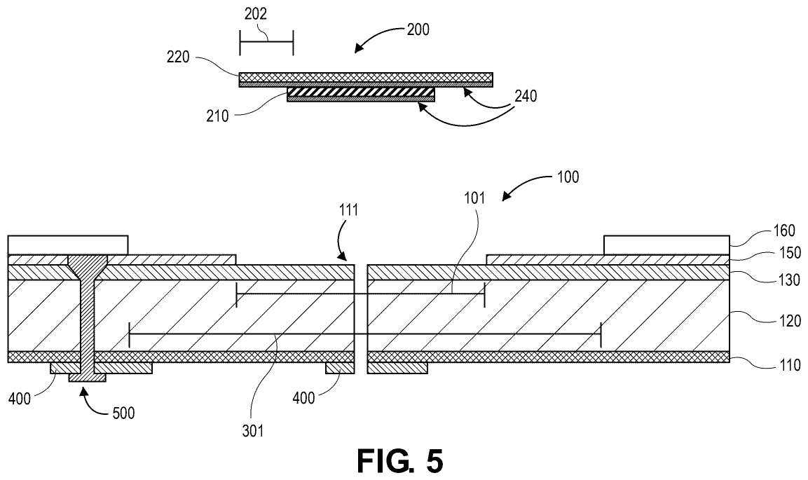

Accordingly, as illustrated in FIGS. 4-5, applying the composite repair patch 200 over the repair area 101 can comprise removing a portion of the surfacer layer 160 to expose at least a portion of the outer layer 130 over the repair area 101. In other implementations, applying the composite repair patch 200 over the repair area 101 can comprise removing a portion of the surfacer layer 160 to expose at least a portion of the base conductive layer 150. The portion of the surfacer layer 160 removed can correspond to a size of the overlap area 301 and/or the size of the conductive layer 300. The portion of exposed outer layer 130 can correspond to the size of the repair area 101 and/or the size of the composite repair patch 200, and the portion of exposed base conductive layer 150 can correspond to the size of the overlap area 301 and/or the size of the conductive layer 300. Accordingly, applying the composite repair patch 200 over the repair area 101 can comprise removing a portion of the surfacer layer 160 to expose at least a portion of the outer layer 130 over the repair area 101 and to expose at least a portion of the base conductive layer 150 corresponding to the conductive layer 300/

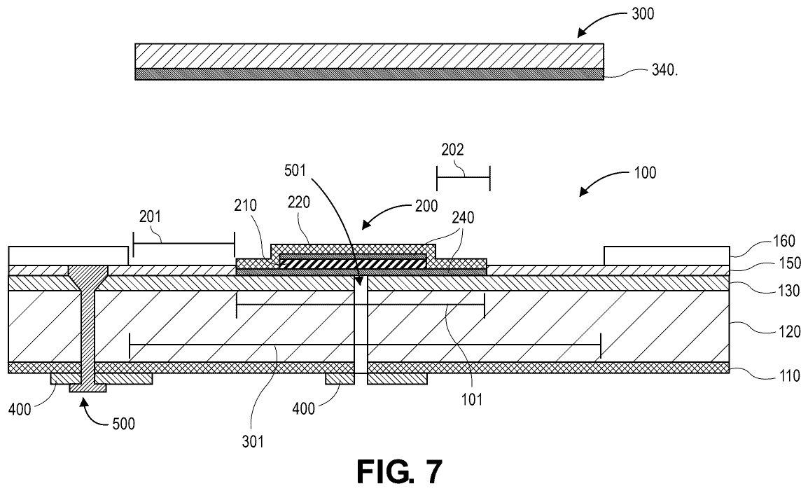

As illustrated in FIG. 3, in some implementations, the repair area 101 includes one or more mechanical fasteners 500. Accordingly, as illustrated in FIG. 5, applying the composite repair patch 200 over the repair area 101 can include removing the one or more mechanical fasteners 500 in the repair area 101. As illustrated in FIG. 7, the space 501 resulting from the removal of the one or more mechanical fasteners 500 can be filled before applying the composite repair patch 200. For example, a suitable materials, such as an filler or potting material can be applied to fill the space 501 before applying the composite repair patch 200.

As illustrated in FIGS. 6-7, the composite repair patch 200 is applied to the outer layer 130 over the repair area 101. As illustrated in FIG. 7, the composite repair patch 200 can be applied over a filled-in space 501 corresponding to the one or more mechanical fasteners 500 removed from the repair area 101. Accordingly, applying the composite repair patch 200 over the repair area 101 can include directly applying the composite repair patch 200 to the exposed outer layer 130. As illustrated in FIGS. 6-7, in some implementations, after removing the base conductive layer 150 to expose the outer layer 130 over the repair area 101, the composite repair patch 200 does not cover the remaining exposed base conductive layer 150.

In some implementations, applying the composite repair patch 200 over the repair area 101 includes applying the composite repair patch 200 over one or more filled-in spaces 501 corresponding to the one or more mechanical fasteners 500 removed from the repair area 101.

As illustrated in FIGS. 6-7, applying the composite repair patch 200 over the repair area 101 can include applying the composite repair patch 200 over at least a portion of the exposed outer layer 130. In one implementation, after the composite repair patch 200 is applied, an exposed overlap area 201 remains. Exposed overlap area 201 comprises at least a portion of the exposed outer layer 130 not covered by the composite repair patch 200. The exposed overlap area 201 allows the conductive layer 300 to overlap the composite repair patch 200. In certain implementations, a base conductive layer 150 is disposed over the outer layer 130 and the exposed overlap area 201 can include at least a portion of the exposed base conductive layer 150 not covered by the composite repair patch 200.

Accordingly, in some implementations, the composite repair patch 200 does not cover an entirety of the exposed outer layer 130, and the composite repair patch 200 does not cover an exposed portion of the base conductive layer 150. Applying the composite repair patch 200 over the repair area 101 can include creating an exposed overlap area 201 on the outer layer 130 and/or the base conductive layer 150 not covered by the composite repair patch 200.

Operation 630 includes applying a conductive layer 300 over the composite repair patch 200 and at least a portion of the composite structure 100 surrounding the composite repair patch 200. The conductive layer 300 can be applied over the overlap area 301 corresponding to the conductive layer 300 and surrounding the composite repair patch 200. The conductive layer 300 can cover a larger area than the composite repair patch 200. Accordingly, when disposed over the composite repair patch 200, the conductive layer 300 can overlap the composite repair patch 200 by from about 0.5 inches to about 10 inches. For example, the conductive layer 300 can overlap the composite repair patch 200 by from about 1.0 inch to about 3.0 inches, or by at least 1 inch, by at least 2 inches, and by at least 3 inches.

As illustrated in FIGS. 6-9. The conductive layer 300 can be the same or similar to the base conductive layer 150 described above. For example, the conductive layer 300 can have the same or similar dimensions, materials, and specifications as the base conductive layer 150 described above. In one implementation, the conductive layer 300 is configured to match the base conductive layer 150. The conductive layer 300 can comprise a metal or metal alloy. For example, the conductive layer 300 can comprise copper, aluminum, titanium, nickel, bronze, gold, silver, or alloys thereof. In one implementation, the conductive layer 300 comprises copper or a copper alloy. The conductive layer 300 can comprise a single ply of conductive material, such as a metal or metal alloy, or can comprise one or more layers of conductive material. The conductive layer 300 comprise an expanded metal foil. In some implementations, the conductive layer 300 comprises a perforated layer, such as a conductive mesh or perforated foil. For example, the conductive layer 300 can comprise a perforated copper foil. The conductive layer 300 can be perforated to decrease an overall weight of the conductive layer 300 and/or to increase a formability of the conductive layer 300. The conductive layer 300 can have a thickness of from about 0.005 inches (5 mil) to about 0.020 inches (20 mil).

The conductive layer 300 can include an adhesive layer 340. The adhesive layer 340 can be configured to bond the conductive layer 300 to the composite repair patch 200 and to bond the conductive layer 300 to the exterior surface of the composite structure 100, such as the outer layer 130.

The adhesive layer 340 can comprise materials configured to bond metal or metallic materials and composite materials. For example, the adhesive layer 340 can comprise thermosetting materials, film adhesives, and/or structural film adhesives, such as a pre-cured thermoset material or a thermoplastic material, such as a pressure-sensitive or heat-activated adhesive. The adhesive layer 340 can comprise an epoxy. For example, the adhesive layer 340 can comprise an epoxy film adhesive, such as AF555 from the 3M Company or MB1515 from Cytec Engineered Materials, particularly suited for use with composite materials.

The conductive layer 300 can be sized to cover the composite repair patch 200 and at least a portion of the composite structure 100 surrounding the composite repair patch 200. The conductive layer 300 can have a size from about 1.0 inch to about 5 feet or greater. For example, as illustrated in FIGS. 6-9, the conductive layer 300 can have a size larger than the repair area 101 and the composite repair patch 200. In some implementations, the conductive layer 300 can have a size corresponding to the size of the overlap area 301 and the overlap area 301 can correspond to the total area exposed after removal of the surfacer layer 160. For example, the overlap area 301 can include all of the exposed portions of the base conductive layer 150 together with all of the exposed outer layer 130. In other implementations, such as when the composite structure 100 does not include a base conductive layer 150, the overlap area 301 includes all of the portions of the outer layer 130 exposed after removal of the surfacer layer 160.

In some implementations, the conductive layer 300 can have a size sufficient to cover the exposed overlap area 201 remaining after the composite repair patch 200 is disposed over the repair area 101. For example, the exposed overlap area 201 can cover an area from about 0.5 inches to about 10 inches surrounding the disposed composite repair patch 200 and the conductive layer 300 can cover an area from about 0.5 inches to about 10 inches surrounding the disposed composite repair patch 200. The exposed overlap area 201 can cover an area from about 1.0 inch to about 3.0 inches surrounding the disposed composite repair patch 200 and the conductive layer 300 can cover an area from about 1.0 inch to about 3.0 inches surrounding the disposed composite repair patch 200, such as, by at least 1.0 inch, by at least 2.0 inches, and by at least 3.0 inches.

As described above, the repair area 101 can include one or more mechanical fasteners 500. And, applying the composite repair patch 200 over the repair area 101 can include removing the one or more mechanical fasteners 500 in the repair area 101. As illustrated in FIG. 7, the space 501 resulting from the removal of the one or more mechanical fasteners 500 can be filled before applying the composite repair patch 200. Accordingly, applying the composite repair patch 200 over the repair area 101 can include filling in one or more spaces 501 before applying the composite repair patch 200 over the repair area 101.

As illustrated in FIG. 9, applying the conductive layer 300 over the composite repair patch 200 and at least a portion of the composite structure 100 surrounding the composite repair patch 200 can further include disposing one or more mechanical fasteners 500 through the conductive layer 300 and the composite repair patch 200 in the repair area 101. The one or more mechanical fasteners 500 can be disposed through the filled-in space 501 corresponding to the one or more mechanical fasteners 500 previously removed from the repair area 101.

The conductive layer 300 can surround the one or more mechanical fasteners 500 disposed in the repair area 101 to enhance an energy distribution of a lightning strike flowing along the exterior portion of the composite structure 100. The one or more mechanical fasteners 500 can be disposed through the conductive layer 300, such that the one or more mechanical fasteners 500 are in direct contact with the conductive layer 300 and the conductive layer 300 creates a conductive bridge for the one or more mechanical fasteners 500 over the composite repair patch 200. The conductive layer 300 can cover an area from about 0.5 inches to about 10 inches around each of the one or more mechanical fasteners 500 in the repair area 101.

The conductive layer 300 can be configured to create a conductive bridge over the composite repair patch 200. For example, the conductive layer 300 can be applied to directly contact an outer layer 130 of the composite structure 100 and/or a base conductive layer 150 disposed over the composite structure 100. In some implementations, the conductive layer 300 can further surround the one or more mechanical fasteners 500 disposed in the repair area 101, and the conductive layer 300 can create a conductive bridge for the one or more mechanical fasteners 500 over the composite repair patch 200.

While not bound to any particular theory, it is believed that when the conductive layer 300 is applied over the composite repair patch 200, an electric energy dispersion along an exterior surface of the composite structure 100 is improved, especially when repair area 101 includes one or more mechanical fasteners 500 and the conductive layer 300 creates a conductive bridge for the one or more mechanical fasteners 500 over the composite repair patch 200. For example, when lightning strikes an aircraft fuselage joined by one or more mechanical fasteners 500, a significant portion of the current may concentrate around or through the one or more mechanical fasteners 500. Differences in the conductive properties between the materials joined by the one or more mechanical fasteners 500 can produce heat or sparking and/or delamination that must be mitigated. Accordingly, the dispersion of lightning currents traveling through structural joints via the one or more mechanical fasteners 500 fasteners can be enhanced by the conductive bridge created by the conductive layer 300 disposed over the composite repair patch 200 and in contact with and/or surrounding the one or more mechanical fasteners 500 to provide an enhanced pathway for current mobility. Similarly, the dispersion of lightning currents traveling through a base conductive layer 150 disposed over the composite structure 100 and/or traveling through an outer layer 130 of the composite structure 100 including conductive elements can be similarly provided by the conductive bridge created by the conductive layer 300 disposed over the composite repair patch 200 and in contact with the base conductive layer 150 and/or the outer layer 130. In some cases, just the conductive layer 300 disposed over the composite repair patch 200 can create localized areas of electrical dispersion over the composite repair patch 200 and/or corresponding to the conductive layer 300 applied to the composite structure 100.

In one implementation, the composite structure 100 comprises an outer layer 130 comprising conductive elements. For example, the outer layer 130 can be conductive and can comprise an inter woven wire fabric (IWWF) layer comprising carbon fibers. Accordingly, applying the conductive layer 300 over the composite repair patch 200 and the portion of the composite structure 100 surrounding the composite repair patch 200 can include applying the conductive layer 300 to directly contact the exposed outer layer 130 in the overlap area 301 to create a conductive bridge for the outer layer 130 over the composite repair patch 200.

In another implementation, a base conductive layer 150 is disposed over the composite structure 100, and the conductive layer 300 is applied to directly contact at least a portion of the base conductive layer 150 surrounding the composite repair patch 200. Accordingly, applying the conductive layer 300 over the composite repair patch 200 and the portion of the composite structure 100 surrounding the composite repair patch 200 can include applying the conductive layer 300 to directly contact exposed base conductive layer 150 in the overlap area 301, such as the exposed base conductive layer 150 surrounding the composite repair patch 200, to create a conductive bridge for the base conductive layer 150 over the composite repair patch 200.

In yet another implementation, one or more mechanical fasteners 500 are disposed through the conductive layer 300 and the composite repair patch 200, and the one or more mechanical fasteners 500 are in direct contact with the conductive layer 300. Accordingly, applying the conductive layer 300 over the composite repair patch 200 and the portion of the composite structure 100 surrounding the composite repair patch 200 can include disposing one or more mechanical fasteners 500 through the conductive layer 300 and the composite repair patch 200 in the repair area 101 and creating a conductive bridge for the one or more mechanical fasteners 500 over the composite repair patch 200. The conductive layer 300 can cover an area from about 0.5 inches to about 10 inches surrounding the one or more mechanical fasteners 500. In some implementations, all of the one or more mechanical fasteners 500 present in the repair area 101 are surrounded by the conductive layer 300.

In one implementation, an outer surface of the composite structure 100 is non-conductive. For example, the composite structure 100 can comprise an outer layer 130 that does not include conductive elements. Accordingly, when the conductive layer 300 is applied over the composite repair patch 200, the conductive layer 300 can create a localized area of electrical dispersion over the composite repair patch 200.

As illustrated in FIG. 1, operation 640 includes curing the composite repair patch 200 and operation 650 includes curing the conductive layer 300. The curing of the composite repair patch 200 and the curing of the conductive layer 300 can include applying at least one of heat and pressure to the composite repair patch 200 and the conductive layer 300. In some implementations, the composite repair patch 200 and the conductive layer 300 are cured simultaneously.

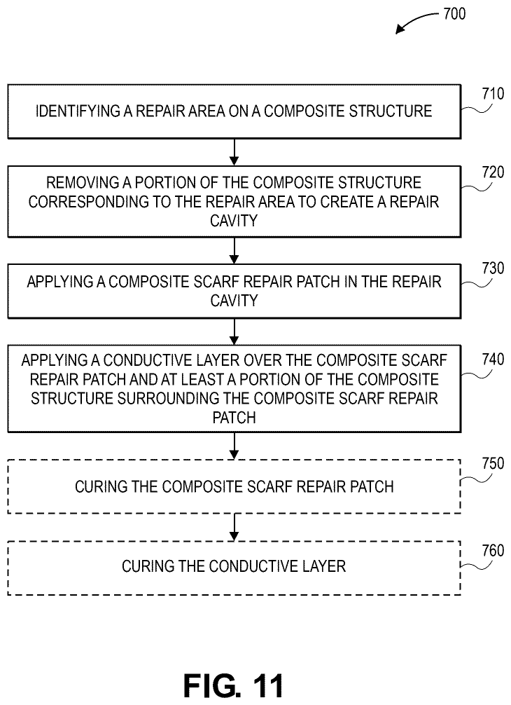

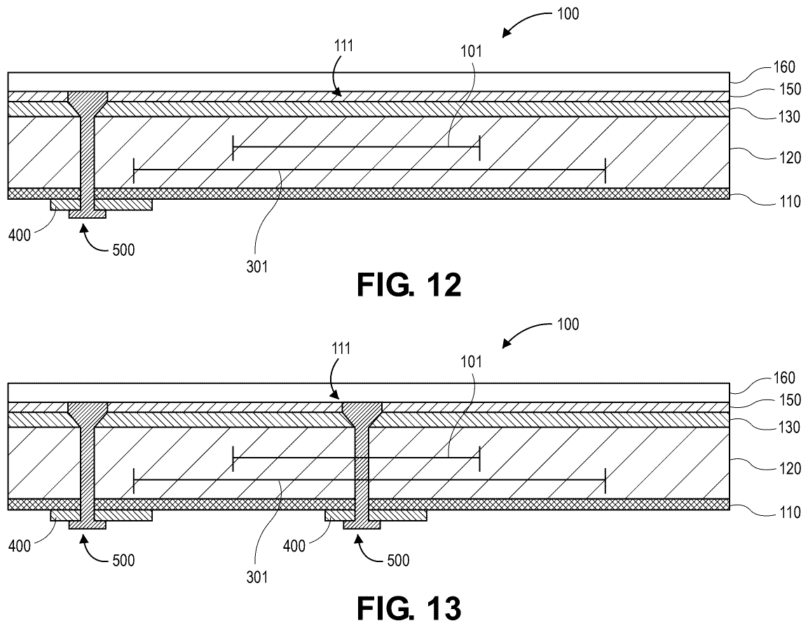

FIG. 11 illustrates a method for repairing a composite structure for electromagnetic effects (EME) protection according to an implementation of the present disclosure. FIGS. 12-19 illustrate a composite structure repair according to implementations of the method illustrated in FIG. 11. FIGS. 12-19 use the same reference numerals to identify same or like structures and elements as illustrated in FIGS. 1-11 and method 600. Accordingly, the description of these structures and elements as described above with respect to FIGS. 1-11 is incorporated in the description of FIGS. 11-19 below.

As illustrated in FIGS. 11-19, a method 700 for repairing a composite structure 100 for electromagnetic effects (EME) protection can include identifying a repair area 101 on a composite structure 100 in operation 710, removing a portion of the composite structure 100 corresponding to the repair area 101 to create a repair cavity 180 in operation 720, applying a composite scarf repair patch 280 in the repair cavity 180 in operation 730, and applying a conductive layer 300 over the composite scarf repair patch 280 and a portion of the composite structure 100 surrounding the composite scarf repair patch 280 in operation 740. The conductive layer 300 can overlap the composite scarf repair patch 280, such as, by from about 0.5 inches to about 10 inches. The conductive layer 300 can include a metal or metal alloy and the conductive layer 300 can create a conductive bridge over the composite scarf repair patch 280 to provide an EME protection to the composite structure 100. For example, the conductive layer 300 can enhance a dispersion of lightning strike energy along the composite structure 100. In some implementations, the method 700 further includes curing the composite scarf repair patch 280 in operation 750 and curing the conductive layer 300 in operation 760.

As illustrated in FIGS. 11-13, the method 700 for repairing a composite structure for EME protection can begin with identifying a repair area 101 on a composite structure 100 in operation 710.

As described above, the composite structure 100 can comprise an inner layer 110, a middle layer 120, and an outer layer 130. The outer layer 130 can comprise an exterior surface of the composite structure 100. For example, an exterior surface of the composite structure 100 can comprise the outer layer 130 disposed over the middle layer 120. In some implementations, the outer layer 130 is conductive and can include one or more conductive elements or layers. For example, the outer layer 130 can comprise an inter woven wire fabric (IWWF) layer comprising carbon fibers.

In other implementations, the outer layer 130 is not conductive and does not include conductive elements or layers. For example, the outer layer 130 can exclude an IWWF layer and/or carbon fibers.

As illustrated in FIGS. 12-19, in some implementations, a base conductive layer 150 can be disposed over at least a portion of the composite structure 100. For example, a base conductive layer 150 can be disposed over at least a portion of the outer layer 130 in the repair area 101.

In some implementations, the outer layer 130 is conductive and the base conductive layer 150 can be electrically connected to the outer layer 130. The base conductive layer 150 and the outer layer 130 can define one or more conductive pathways to reduce an energy density of a lightning strike flowing across the composite structure 100.

As illustrated in FIGS. 12-19, an internal framework 400 can be joined to the composite structure 100 using one or more mechanical fasteners 500. The one or more mechanical fasteners 500 can be disposed through the composite structure 100. For example, the one or more mechanical fasteners 500 can be disposed through the inner layer 110, the middle layer 120, and the outer layer 130 of the composite structure 100. As described above, the base conductive layer 150 can be disposed over the composite structure 100, and the one or more mechanical fasteners 500 can be disposed through the base conductive layer 150 and the composite structure 100.

The base conductive layer 150 can be configured to surround at least one of the one or more mechanical fasteners 500 disposed through the outer layer 130.

In some implementations, one or more outer protection layers or coatings, such as a surfacer layer 160, can be disposed over an exterior surface of the composite structure 100. For example, a surfacer layer 160 can be disposed over the outer layer 130. In other implementations, a surfacer layer 160 is disposed over a base conductive layer 150 disposed over the outer layer 130.

The repair area 101 can correspond to damage found in the composite structure 100. For example, as illustrated in FIGS. 12-13, a repair area 101 can comprise an area surrounding a damage area 111. The damaged area 111 can be determined by visual inspection or via nondestructive evaluation (NDE) techniques, such as impedance testing, x-ray radiography, thermography, and ultrasonics. In other implementations, the repair area 101 corresponds to areas of the composite structure 100 where EME protection is desired.

The repair area 101 can define an area from about 1.0 inch to about 5 feet or greater surrounding the damage area 111. In some implementations, the repair area extends beyond a surface of the composite structure 100, and the repair area 101 can include one or more layers of the composite structure 100. For example, the damage area 111 can extend into a body of the composite structure 100 and the repair area can be sufficiently deep to address the extent of damage.

As described above, the repair area 101 can include at least one of a surfacer layer 160, a base conductive layer 150, an outer layer 130, and one or more mechanical fastener 500.

In some implementations, the repair area 101 corresponds to a size of the composite scarf repair patch 280. The repair area 101 can correspond to a size to be covered and/or replaced by the composite scarf repair patch 280. For example, the size of the repair area 101 can accommodate a bottom layer 281 of the composite scarf repair patch 280 and a top layer 220 of the composite scarf repair patch 280. However, to ensure overlap by the conductive layer 300, the repair area 101 is smaller than an area covered by the conductive layer 300. For example, the repair area 101 is smaller than an overlap area 301 corresponding to the conductive layer 300, such that the conductive layer 300 can overlap the composite scarf repair patch 280, such as, by from about 0.5 inches to about 10 inches, by from about 1.0 inch to about 3 inches, or by at least 1.0 inch, by at least 2.0 inches, and by at least 3.0 inches.

Operation 720 includes removing a portion of the composite structure 100 corresponding to the repair area 101 to create a repair cavity 180. As described above, an exterior surface of the composite structure 100 can include an outer layer 130, and removing the portion of the composite structure 100 corresponding to the repair area 101 to create the repair cavity 180 can include removing a portion of the outer layer 130 to create the repair cavity 180.

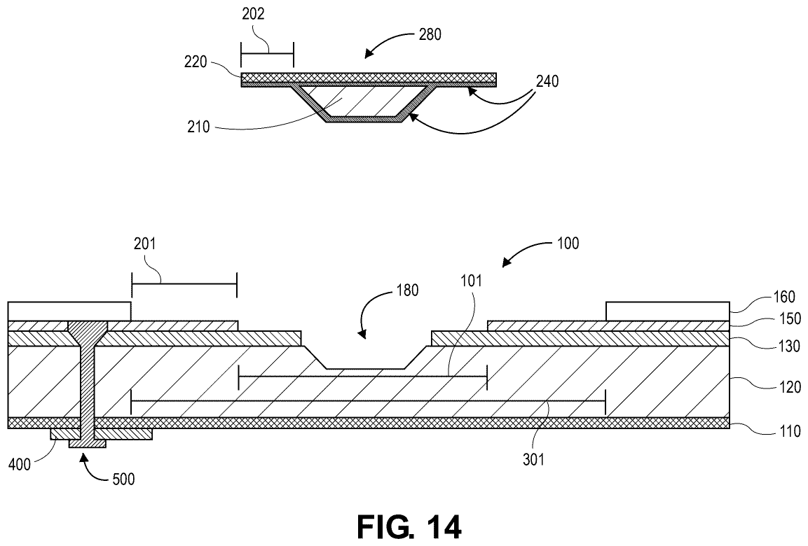

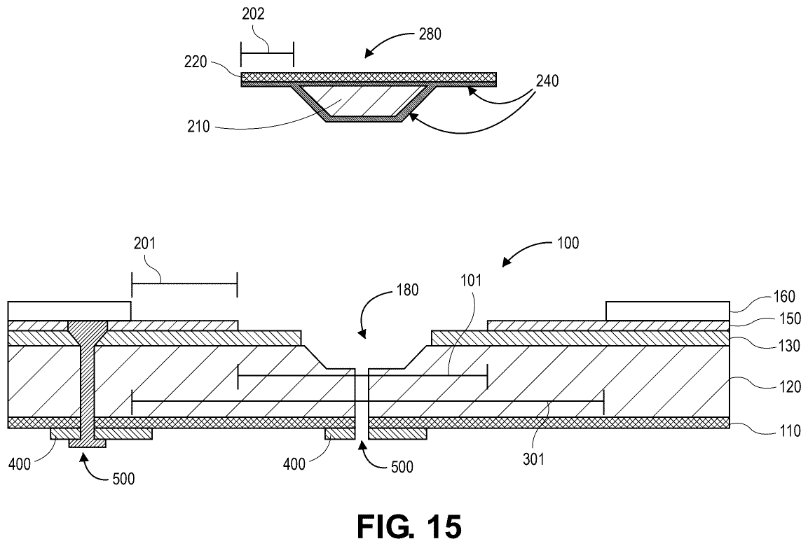

As described above, in some implementations, a base conductive layer 150 is disposed over the composite structure 100. For example, a base conductive layer 150 can be disposed over at least a portion of the outer layer 130 in the repair area 101. Accordingly, as illustrated in FIGS. 14-15, removing the portion of the composite structure 100 corresponding to the repair area 101 to create the repair cavity 180 includes removing a portion of the base conductive layer 150 to expose the outer layer 130 in the repair area 101. The portion of the base conductive layer 150 removed can correspond to a size of the repair area 101 and/or a size of the composite scarf repair patch 280 and the portion of exposed outer layer 130 can correspond to the size of the repair area 101 and/or the size of the composite scarf repair patch 280. In some implementations, the portion of the base conductive layer 150 removed is smaller than a size of the overlap area 301 and/or a size of the conductive layer 300, and the portion of exposed outer layer 130 is smaller than the size of the overlap area 301 and/or the size of the conductive layer 300.

As described above, in some implementations, a surfacer layer 160 is disposed over the base conductive layer 150 and/or the composite structure 100. For example, the surfacer layer 160 can be disposed over the outer layer 130. Accordingly, as illustrated in FIGS. 14-15, removing the portion of the composite structure 100 corresponding to the repair area 101 to create the repair cavity 180 can include removing a portion of the surfacer layer 160 to expose the outer layer 130 corresponding to the repair area 101. In other implementations, removing a portion of the composite structure 100 corresponding to the repair area 101 to create a repair cavity 180 can comprise removing a portion of the surfacer layer 160 to expose at least a portion of the base conductive layer 150 corresponding to an overlap area 301 and/or corresponding to the conductive layer 300. In some implementations, the composite structure 100 does not include a base conductive layer 150, and the portion of the surfacer layer 160 removed can correspond to a size of the overlap area 301 and/or the size of the conductive layer 300, and the size of the outer layer 130 exposed can correspond to the size of the overlap area 301 and/or the size of the conductive layer 300. In some implementations, the composite structure 100 includes a base conductive layer 150, and the portion of exposed outer layer 130 can correspond to at least the size of the repair area 101 and/or the size of the composite scarf repair patch 280, and the portion of exposed base conductive layer 150 can correspond to the size of the overlap area 301 and/or the size of the conductive layer 300. For example, removal of the surfacer layer 160 can expose an overlap area 301 on the base conductive layer 150.

As illustrated in FIG. 13, in some implementations, the repair area 101 includes one or more mechanical fasteners 500. Accordingly, as illustrated in FIG. 15, removing a portion of the composite structure 100 corresponding to the repair area 101 to create a repair cavity 180 can include removing the one or more mechanical fasteners 500 in the repair area 101.

As illustrated in FIGS. 14 and 15, a portion of the composite structure 100 is removed in the repair area 101 to create a repair cavity 180. For example, at least a portion of the outer layer 130 and/or the middle layer 120 can be removed to create the repair cavity 180.

The repair cavity 180 can be sized to correspond to a size of the composite scarf repair patch 280. The repair cavity 180 can be tapered to promote bonding between the composite scarf repair patch 280 and the composite structure 100.

Operation 740 includes applying a composite scarf repair patch 280 in the repair cavity 180.

The composite scarf repair patch 280 can be configured to be compatible with the composite structure 100. The composite scarf repair patch 280 can comprise the same or similar materials as the composite structure 100 and/or the composite repair patch 200 described above. For example, the composite scarf repair patch 280 can comprise one or more composite materials, such as, one or more laminated plies of a fiber reinforced resin, a combination of epoxy resin and carbon fibers, and/or one or more layers of a carbon fiber reinforced thermoset or thermoplastic.

In some implementations, the composite scarf repair patch 280 does not include conductive elements. For example, in some implementations, the composite scarf repair patch 280 is dielectric and the composite scarf repair patch 280 does not include IWWF layers, IWWF layers comprising carbon fibers, and/or carbon fibers.

In other implementations, the composite scarf repair patch 280 can be conductive. For example, the composite scarf repair patch 280 can include one or more conductive elements or layers, such as an IWWF layer, an IWWF layer comprising carbon fibers, carbon fibers, and the like.

As illustrated in FIGS. 12-19, in some implementations the composite scarf repair patch 280 can comprise two or more layers. For example, the composite structure 100 can comprise a bottom layer 210 and a top layer 220 similar to those described above with respect to the composite repair patch 200. The composite structure 100 can further comprise one or more adhesive layers 240 to bond the bottom layer 210 and the top layer 220, and/or to bond the composite scarf repair patch 280 to the composite structure 100. In other implementations, the two or more layers of the composite scarf repair patch 280 can be cured or fusion bonded together without the use of an adhesive layer.

The bottom layer 210 can be configured to be disposed within the repair cavity 180. In some implementations, the bottom layer 210 does not include conductive elements. For example, the bottom layer 210 can exclude IWWF layers, IWWF layers comprising carbon fibers, and/or carbon fibers. In other implementations, the bottom layer 210 can be conductive. For example, the bottom layer 210 can include one or more conductive elements or layers. For example, the bottom layer 210 can comprise IWWF layers, IWWF layers comprising carbon fibers, carbon fibers and/or the like. In some implementations, the composite scarf repair patch 280 comprises similar materials as the composite structure 100 in the repair cavity 180. In other implementations, the composite scarf repair patch 280 is non-conductive regardless of the material in the repair cavity 180 and/or the composite structure 100.

The top layer 220 can be disposed over the bottom layer 210. The top layer 220 can comprise an exterior surface of the composite scarf repair patch 280. The top layer 220 can comprise one or more composite materials. For example, top layer 220 can comprise a plain weave fabric (PW).

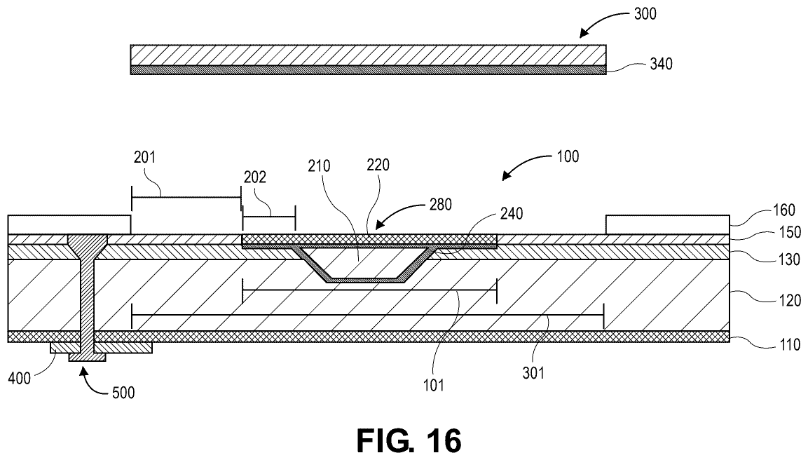

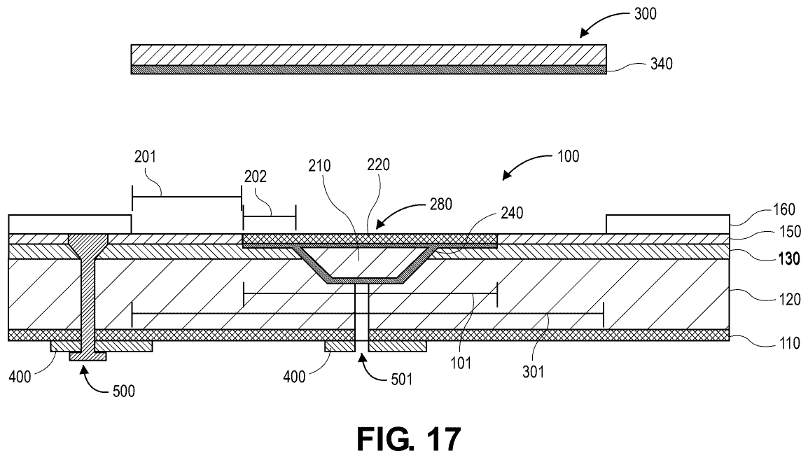

The composite scarf repair patch 280 can be sized to fit the repair cavity 180 and to cover the repair area 101. For example, as illustrated in FIGS. 16-17, at least one of the top layer 220 and the bottom layer 210 can have a size corresponding to a size of the repair cavity 180 and/or the repair area 101. In one implementation, the top layer 220 has a size corresponding to a size of the repair area 101 and the bottom layer has a size corresponding to a size of the repair cavity 180.

In some implementations, a size of the top layer 220 corresponds to a size of the repair area 101 and the bottom layer 210 has a size smaller than the repair area 101. For example, the bottom layer 210 can be sized only to fit within the repair cavity 180 that is smaller than an exterior surface of the repair area 101 covered by the top layer 220. For example, the top layer 220 can be larger than the bottom layer 210. As illustrated in FIGS. 14-17, the top layer 220 can define an overhang area 202 over the bottom layer 210. Accordingly, when disposed within the repair cavity 180, the top layer 220 can bond directly to the composite structure 100 and/or the portion of the exposed outer layer 130 in the overhang area 202.

As illustrated in FIGS. 17-19, in some implementations, the composite scarf repair patch 280 is smaller than a size of the overlap area 301 and/or a size of the conductive layer 300, and the top layer 220 and the bottom layer 210 have a size smaller than the size of the overlap area 301 and the size of the conductive layer 300.

The one or more adhesive layers 240 can be configured to bond the composite scarf repair patch 280 to the composite structure 100. For example, the one or more adhesive layers 240 can permanently bond the composite scarf repair patch 280 to the composite structure 100. In some implementations, the one or more adhesive layers 240 are cured to bond the composite scarf repair patch 280 to the composite structure 100. For example, the one or more adhesive layers 240 require application of a heat or pressure to bond the composite scarf repair patch 280 to the composite structure 100.

As illustrated in FIGS. 16-17, the composite scarf repair patch 280 is applied to the outer layer 130 and the repair cavity 180. As illustrated in FIG. 17, in some implementations, the composite scarf repair patch 280 can be applied over a filled-in space 501 corresponding to the one or more mechanical fasteners 500 removed from the repair area 101. Accordingly, applying the composite scarf repair patch 280 in the repair cavity 180 can include applying the composite scarf repair patch 280 to the outer layer 130 and repair cavity 180. As illustrated in FIGS. 16-17, in some implementations, the composite scarf repair patch 280 does not cover the exposed base conductive layer 150. For example, after application of the composite scarf repair patch 280 an exposed overlap area 201 remains where the base conductive layer 150 is not covered by the composite scarf repair patch 280.

As illustrated in FIGS. 16-17, applying the composite scarf repair patch 280 in the repair cavity 180 can include applying the composite scarf repair patch 280 over at least a portion of the exposed outer layer 130. As described above, after the composite scarf repair patch 280 is applied, an exposed overlap area 201 can remain. Exposed overlap area 201 comprises at least a portion of the exposed outer layer 130 not covered by the composite scarf repair patch 280. In certain implementations, a base conductive layer 150 is disposed over the outer layer 130 and the exposed overlap area 201 can include at least a portion of the exposed base conductive layer 150 not covered by the composite scarf repair patch 280. The exposed overlap area 201 is configured to allow the conductive layer 300 to overlap the composite scarf repair patch 280 once installed.

Accordingly, in some implementations, the composite scarf repair patch 280 does not cover an entirety of the exposed outer layer 130, and the composite scarf repair patch 280 does not cover an exposed portion of the base conductive layer 150. Applying the composite scarf repair patch 280 over the repair area 101 can include creating an exposed overlap area 201 on the outer layer 130 and/or the base conductive layer 150 not covered by the composite scarf repair patch 280.

Operation 740 includes applying a conductive layer 300 over the composite scarf repair patch 280 and at least a portion of the composite structure 100 surrounding the composite scarf repair patch 280.

As illustrated in FIGS. 16-19. The conductive layer 300 can be the same or similar to the base conductive layer 150 described above. For example, the conductive layer 300 can have the same or similar dimensions, materials, and specifications as the base conductive layer 150 described above. The conductive layer 300 can comprise a metal or metal alloy. For example, the conductive layer 300 can comprise copper, aluminum, titanium, nickel, bronze, gold, silver, or alloys thereof. In one implementation, the conductive layer 300 comprises copper or a copper alloy. The conductive layer 300 can comprise a single ply of conductive material, such as a metal or metal alloy, or can comprise one or more layers of conductive material. The conductive layer 300 comprises an expanded metal foil. In some implementations, the conductive layer 300 comprises a perforated layer, such as a conductive mesh or perforated foil. For example, the conductive layer 300 can comprise a perforated copper foil. The conductive layer 300 can be perforated to decrease an overall weight of the conductive layer 300. The conductive layer 300 can have a thickness of from about 0.005 inches (5 mil) to about 0.020 inches (20 mil).

The conductive layer 300 can include an adhesive layer 340. The adhesive layer 340 can be configured to bond the conductive layer 300 to the composite scarf repair patch 280 and to bond the conductive layer 300 to the exterior surface of the composite structure 100, such as the outer layer 130.

The adhesive layer 340 can comprise materials configured to bond metal or metallic materials and composite materials. For example, the adhesive layer 340 can comprise thermosetting materials, film adhesives, and/or structural film adhesives. The adhesive layer 340 can also comprise an epoxy film adhesive, such as AF555 from the 3M Company or MB1515 from Cytec Engineered Materials, particularly suited for use with composite materials.

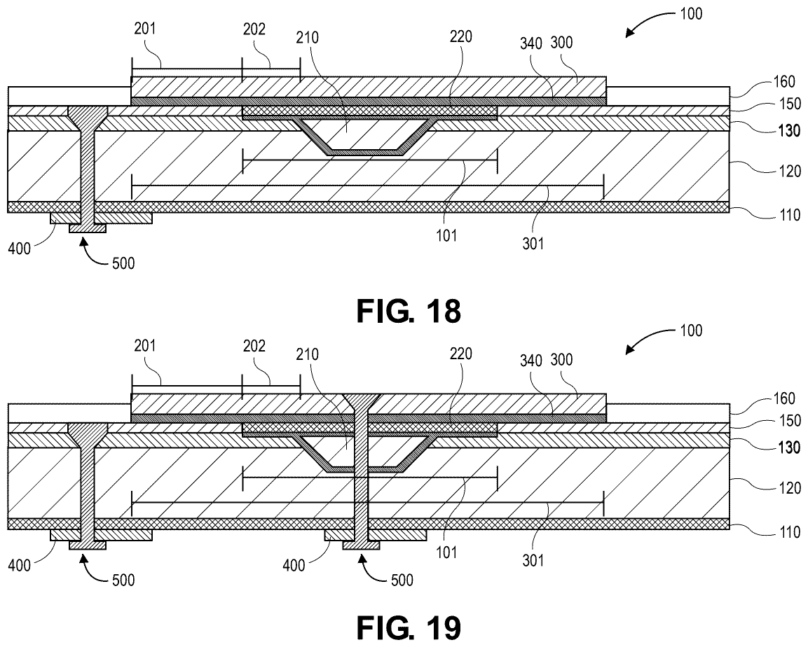

The conductive layer 300 can be sized to cover the composite scarf repair patch 280 and at least a portion of the composite structure 100 surrounding the composite scarf repair patch 280. For example, as illustrated in FIGS. 18-19, the conductive layer 300 can have a size larger than the repair area 101 and the composite scarf repair patch 280 and the conductive layer 300 can overlap the composite scarf repair patch 280, such as, by from about 0.5 inches to about 10inches, by from about 1.0 inch to about 3 inches, or by at least 1.0 inch, by at least 2.0 inches, and by at least 3.0 inches. In some implementations, the conductive layer 300 can have a size corresponding to the size of the overlap area 301 and the overlap area 301 can correspond to the total area exposed after removal of the surfacer layer 160. For example, the overlap area 301 can include all of the exposed portions of the base conductive layer 150 together with all of the exposed outer layer 130. In other implementations, such as when the composite structure 100 does not include a base conductive layer 150, the overlap area 301 includes all of the portions of the outer layer 130 exposed after removal of the surfacer layer 160.

In some implementations, the conductive layer 300 can have a size sufficient to cover the exposed overlap area 201 remaining after the composite scarf repair patch 280 is applied over the repair area 101. For example, the exposed overlap area 201 can cover an area from about 0.5 inches to about 10 inches surrounding the applied composite scarf repair patch 280 and the conductive layer 300 can cover an area from about 0.5 inches to about 10 inches surrounding the disposed composite scarf repair patch 280. The exposed overlap area 201 can cover an area from about 1.0 inch to about 3.0 inches surrounding the applied composite scarf repair patch 280 and the conductive layer 300 can cover an area from about from about 1.0 inch to about 3.0 inches surrounding the disposed composite scarf repair patch 280, such as, by at least 1.0 inch, by at least 2.0 inches, and by at least 3.0 inches.

As described above, the repair area 101 can include one or more mechanical fasteners 500. And, applying a composite scarf repair patch 280 in the repair cavity 180 can include removing the one or more mechanical fasteners 500 in the repair area 101. As illustrated in FIG. 17, the space 501 resulting from the removal of the one or more mechanical fasteners 500 can be filled before applying the composite scarf repair patch 280. Accordingly, applying the composite scarf repair patch 280 in the repair cavity 180 can include filling in one or more spaces 501 before applying the composite scarf repair patch 280 in the repair cavity 180.

As illustrated in FIG. 19, applying the conductive layer 300 over the composite scarf repair patch 280 and at least the portion of the composite structure 100 surrounding the composite scarf repair patch 280 can further include disposing one or more mechanical fasteners 500 through the conductive layer 300 and the composite scarf repair patch 280 in the repair area 101. In some implementations, all mechanical fasteners 500 removed from the repair area 101 are replaced or reinstalled after applying the conductive layer 300. The one or more mechanical fasteners 500 can be disposed through the filled-in space 501 corresponding to the one or more mechanical fasteners 500 previously removed from the repair area 101.

The conductive layer 300 can surround the one or more mechanical fasteners 500 disposed in the repair area 101 to enhance an energy distribution of a lightning strike flowing along the exterior portion of the composite structure 100. The one or more mechanical fasteners 500 can be disposed through the conductive layer 300, such that the one or more mechanical fasteners 500 are in direct contact with the conductive layer 300 and the conductive layer 300 creates a conductive bridge for the one or more mechanical fasteners 500 over the composite scarf repair patch 280. The conductive layer 300 can cover an area from about 0.5 inches to about 10 inches around each of the one or more mechanical fasteners 500 in the repair area 101.

As illustrated in FIGS. 18-19, the conductive layer 300 can be configured to create a conductive bridge over the composite scarf repair patch 280. For example, the conductive layer 300 can be applied to directly contact an outer layer 130 of the composite structure 100 and/or a base conductive layer 150 disposed over the composite structure 100. In some implementations, the conductive layer 300 can further surround the one or more mechanical fasteners 500 disposed in the repair area 101, and the conductive layer 300 can create a conductive bridge for the one or more mechanical fasteners 500 over the composite scarf repair patch 280.

While not bound to any particular theory, it is believed that when the conductive layer 300 is applied over the composite scarf repair patch 280, an electric energy dispersion along an exterior surface of the composite structure 100 is provided, especially when repair area 101 includes one or more mechanical fasteners 500 and the conductive layer 300 creates a conductive bridge for the one or more mechanical fasteners 500 over the composite scarf repair patch 280. For example, when lightning strikes an aircraft fuselage joined by one or more mechanical fasteners 500, a significant portion of the current may concentrate around or through the one or more mechanical fasteners 500. Differences in the conductive properties between the materials joined by the one or more mechanical fasteners 500 can produce heat or sparking that must be mitigated. Accordingly, the dispersion of lightning currents traveling through structural joints via the one or more mechanical fasteners 500 fasteners can be enhanced by the conductive bridge created by the conductive layer 300 disposed over the composite scarf repair patch 280 and in contact with and/or surrounding the one or more mechanical fasteners 500 to provide an enhanced pathway for current mobility. Similarly, the dispersion of lightning currents traveling through a base conductive layer 150 disposed over the composite structure 100 and/or traveling through an outer layer 130 of the composite structure 100 including conductive elements can be similarly provided by the conductive bridge created by the conductive layer 300 disposed over the composite scarf repair patch 280 and in contact with the base conductive layer 150 and/or the outer layer 130. In some cases, just the conductive layer 300 disposed over the composite scarf repair patch 280 can create localized areas of electrical dispersion over the composite scarf repair patch 280 and/or corresponding to the conductive layer 300 applied to the composite structure 100.

In one implementation, the composite structure 100 comprises an outer layer 130 comprising conductive elements. For example, the outer layer 130 can be conductive and can comprise an inter woven wire fabric (IWWF) layer comprising carbon fibers. Accordingly, applying the conductive layer 300 over the composite scarf repair patch 280 and at least the portion of the composite structure 100 surrounding the composite scarf repair patch 280 can include applying the conductive layer 300 to directly contact at least a portion of the outer layer 130 surrounding the composite scarf repair patch 280 to create a conductive bridge for the outer layer 130 over the composite scarf repair patch 280.

In another implementation, a base conductive layer 150 is disposed over the composite structure 100, and the conductive layer 300 is applied to directly contact at least a portion of the base conductive layer 150 surrounding the composite scarf repair patch 280. Accordingly, applying the conductive layer 300 over the composite scarf repair patch 280 and at least the portion of the composite structure 100 surrounding the composite scarf repair patch 280 can include applying the conductive layer 300 to directly contact the base conductive layer 150 in the overlap area 301, such as the exposed base conductive layer 150 surrounding the composite scarf repair patch 280, to create a conductive bridge for the base conductive layer 150 over the composite scarf repair patch 280.

In yet another implementation, one or more mechanical fasteners 500 are disposed through the conductive layer 300 and the composite scarf repair patch 280, and the one or more mechanical fasteners 500 are in direct contact with the conductive layer 300. Accordingly, applying the conductive layer 300 over the composite scarf repair patch 280 and at least the portion of the composite structure 100 surrounding the composite scarf repair patch 280 can include disposing one or more mechanical fasteners 500 through the conductive layer 300 and the composite scarf repair patch 280 in the repair area 101 and creating a conductive bridge for the one or more mechanical fasteners 500 over the composite scarf repair patch 280. The conductive layer 300 can cover an area from about 0.5 inches to about 10 inches surrounding the one or more mechanical fasteners 500. In some implementations, all of the one or more mechanical fasteners 500 present in the repair area 101 are surrounded by the conductive layer 300.

In one implementation, an outer surface of the composite structure 100 is non-conductive. For example the composite structure 100 can comprise an outer layer 130 that does not include conductive elements. Accordingly, when the conductive layer 300 is applied over the composite scarf repair patch 280, the conductive layer 300 can create a localized area of electrical dispersion over the composite scarf repair patch 280.

As illustrated in FIG. 1, operation 750 includes curing the composite scarf repair patch 280 and operation 760 includes curing the conductive layer 300. The curing of the composite scarf repair patch 280 and the curing of the conductive layer 300 can include applying at least one of heat and pressure to the composite scarf repair patch 280 and the conductive layer 300. In some implementations, the composite scarf repair patch 280 and the conductive layer 300 are cured simultaneously.

In some implementations, the composite repair patch 200 or the composite scarf repair patch 280 can be provided separately to the conductive layer 300. In other implementations, the composite repair patch 200 or the composite scarf repair patch 280 and the conductive layer 300 can be provided together. Accordingly, as illustrated in FIGS. 1-19, a repair patch for electromagnetic effects (EME) protection of composite structures, can include a composite repair patch 200 or a composite scarf repair patch 280 sized to correspond to a repair area 101 of a composite structure 100; and a conductive layer 300 disposed on the composite repair patch 200 or the composite scarf repair patch 280. The conductive layer 300 can have a size larger than the composite repair patch 200 or the composite scarf repair patch 280. The conductive layer 300 can be configured to overlap the composite repair patch 200 or a composite scarf repair patch 280 when disposed on the composite structure 100. The conductive layer 300 can include a metal or metal alloy, and the conductive layer 300 can be configured to create a conductive bridge over the composite repair patch 200 or the composite scarf repair patch 280.

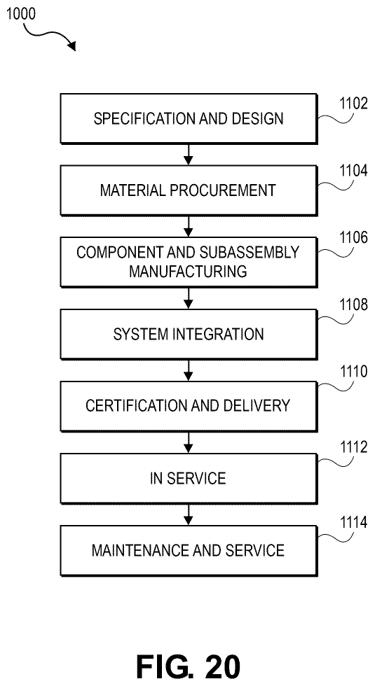

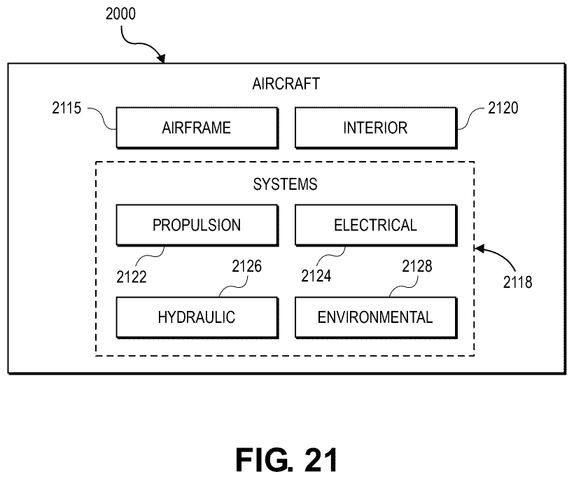

Implementations of the present disclosure may find use in a variety of potential applications, particularly in the transportation industry, including for example, aerospace, marine, rail, automotive applications, and other application where methods for repairing composite structures for electromagnetic effects (EME) protection are desired. However, the present disclosure is not limited thereto, and implementations of the present disclosure may be used in applications outside the transportation industry. Thus, referring now to FIGS. 20 and 21, implementations of the disclosure may be used in the context of an aircraft manufacturing and service method 1000 as shown in FIG. 20 and an aircraft 2000 as shown in FIG. 21. While FIG. 21 is described in terms of an aircraft 2000, the present disclosure is not limited thereto, and the aircraft manufacturing and service method 1000 can be applied to other structures. During pre-production, aircraft manufacturing and service method 1000 may include specification and design 1102 of the aircraft 2000 and material procurement 1104. During production, component, and subassembly manufacturing 1106 and system integration 1108 of the aircraft 2000 takes place. Thereafter, the aircraft 2000 may go through certification and delivery 1110 in order to be placed in service 1112. While in service by a customer, the aircraft 2000 is scheduled for routine maintenance and service 1114, which may also include modification, reconfiguration, refurbishment, and so on.

Each of the processes of aircraft manufacturing and service method 1000 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 21, the aircraft 2000 produced by aircraft manufacturing and service method 1000 may include an airframe 2115 with a plurality of systems 2118 and an interior 2120. Examples of systems 2118 include one or more of a propulsion system 2122, an electrical system 2124, a hydraulic system 2126, and an environmental system 2128. Any number of other systems may be included. Although an aerospace example is shown, the principles of the disclosure may be applied to other industries, such as the marine and automotive industries.

Systems and methods exemplified herein may be employed during any one or more of the stages of the aircraft manufacturing and service method 1000. For example, components or subassemblies corresponding to component and subassembly manufacturing 1106 may be fabricated or manufactured in a manner similar to components or subassemblies produced while the aircraft 2000 is in service. Also, one or more apparatus examples, method examples, or a combination thereof may be utilized during the component and subassembly manufacturing 1106 and system integration 1108, for example, by substantially expediting assembly of or reducing the cost of an aircraft 2000. Similarly, one or more of apparatus examples, method examples, or a combination thereof may be utilized while the aircraft 2000 is in service, for example and without limitation, to maintenance and service 1114.

While FIGS. 20 and 21 describe the disclosure with respect to aircraft and aircraft manufacturing and servicing, the present disclosure is not limited thereto. The systems and methods of the present disclosure may also be used for spacecraft, satellites, rotorcraft, submarines, surface ships, automobiles, autonomous vehicles, tanks, trucks, power plants, railway cars, and any other suitable type of objects.

The present disclosure has been described with reference to exemplary implementations. Although a few implementations have been shown and described, it will be appreciated by those skilled in the art that changes may be made in these implementations without departing from the principles and spirit of preceding detailed description. It is intended that the present disclosure be construed as including all such modifications and alterations insofar as they come within the scope of the appended claims or the equivalents thereof.

What is claimed, is:

1. A method for repairing a composite structure for electromagnetic effects (EME) protection, comprising:
identifying a repair area on a composite structure;
applying a composite repair patch over the repair area; and
applying a conductive layer over the composite repair patch and an area of the composite structure surrounding the composite repair patch,
wherein the conductive layer overlaps the composite repair patch,
wherein the conductive layer comprises a metal or metal alloy, and
wherein the conductive layer creates a conductive bridge over the composite repair patch to provide an EME protection to the composite structure and enhance a dispersion of lightning strike energy along the composite structure.

2. The method of claim 1, wherein an exterior surface of the composite structure comprises an outer layer, and wherein applying the composite repair patch over the repair area comprises applying the composite repair patch to the outer layer over the repair area.

3. The method of claim 2, wherein a surfacer layer is disposed over the outer layer, and wherein applying the composite repair patch over the repair area comprises removing a portion of the surfacer layer to expose the outer layer over the repair area.

4. The method of claim 2, wherein a base conductive layer is disposed over at least a portion of the outer layer, and wherein applying the composite repair patch over the repair area comprises removing the base conductive layer to expose the outer layer over the repair area and applying the composite repair patch to the exposed outer layer.

5. The method of claim 4, wherein a surfacer layer is disposed over the base conductive layer, and wherein applying the composite repair patch over the repair area comprises removing a portion of the surfacer layer to expose the outer layer over the repair area and to expose at least a portion of the base conductive layer corresponding to an overlap area corresponding to the conductive layer.

6. The method of claim 5, wherein applying the conductive layer over the composite repair patch and the area of the composite structure surrounding the composite repair patch comprises applying the conductive layer to directly contact the exposed at least a portion of the base conductive layer in the overlap area to create a conductive bridge for the base conductive layer over the composite repair patch.

7. The method of claim 3, wherein the repair area comprises one or more mechanical fasteners, and wherein applying the composite repair patch over the repair area comprises removing the one or more mechanical fasteners in the repair area and applying the composite repair patch over one or more filled-in spaces corresponding to the one or more mechanical fasteners removed from the repair area.

8. The method of claim 7, wherein applying the conductive layer over the composite repair patch and the area of the composite structure surrounding the composite repair patch comprises disposing one or more mechanical fasteners through the conductive layer and the composite repair patch in the repair area and creating a conductive bridge for the one or more mechanical fasteners over the composite repair patch.

9. The method of claim 3, wherein the outer layer is conductive and comprises an inter woven wire fabric (IWWF) layer comprising carbon fibers, and wherein applying the conductive layer over the composite repair patch and the area of the composite structure surrounding the composite repair patch comprises applying the conductive layer to directly contact the exposed outer layer in an overlap area corresponding to the conductive layer to create a conductive bridge for the outer layer over the composite repair patch.

10. The method of claim 9, wherein the outer layer is disposed over a middle layer, and wherein the middle layer does not include conductive elements to isolate a dispersion of lightning strike energy to the outer layer.

11. A method for repairing a composite structure for electromagnetic effects (EME) protection, comprising:
identifying a repair area on a composite structure;
removing a portion of the composite structure corresponding to the repair area to create a repair cavity;
applying a composite scarf repair patch in the repair cavity; and
applying a conductive layer over the composite scarf repair patch and an area of the composite structure surrounding the composite scarf repair patch,
wherein the conductive layer overlaps the composite scarf repair patch,
wherein the conductive layer comprises a metal or metal alloy, and
wherein the conductive layer creates a conductive bridge over the composite scarf repair patch to provide an EME protection to the composite structure and to enhance a dispersion of lightning strike energy along the composite structure.

12. The method of claim 11, wherein an exterior surface of the composite structure comprises an outer layer, and wherein removing the portion of the composite structure corresponding to the repair area to create the repair cavity comprises removing a portion of the outer layer to create the repair cavity.

13. The method of claim 12, wherein a surfacer layer is disposed over the outer layer, and wherein removing the portion of the composite structure corresponding to the repair area to create the repair cavity comprises removing a portion of the surfacer layer to expose the outer layer corresponding to the repair area.

14. The method of claim 13, wherein a base conductive layer is disposed over at least a portion of the outer layer in the repair area, and wherein removing the portion of the composite structure corresponding to the repair area to create the repair cavity comprises removing a portion of the base conductive layer to expose the outer layer in the repair area.

15. The method of claim 14, wherein a surfacer layer is disposed over the base conductive layer, and wherein removing the portion of the composite structure corresponding to the repair area to create the repair cavity comprises removing a portion of the surfacer layer to expose the outer layer over the repair area and to expose at least a portion of the base conductive layer corresponding to an overlap area corresponding to the conductive layer.

16. The method of claim 15, wherein applying the conductive layer over the composite scarf repair patch and at least the area of the composite structure surrounding the composite scarf repair patch comprises applying the conductive layer to directly contact the base conductive layer in the overlap area to create a conductive bridge for the base conductive layer over the composite scarf repair patch.

17. The method of claim 13, wherein the repair area comprises one or more mechanical fasteners, and wherein removing the portion of the composite structure corresponding to the repair area to create the repair cavity comprises removing the one or more mechanical fasteners in the repair area.

18. The method of claim 17, wherein applying the conductive layer over the composite scarf repair patch and at least the area of the composite structure surrounding the composite scarf repair patch comprises disposing one or more mechanical fasteners through the conductive layer and the composite scarf repair patch in the repair area and creating a conductive bridge for the one or more mechanical fasteners over the composite scarf repair patch.

19. The method of claim 13, wherein the outer layer is conductive and comprises an inter woven wire fabric (IWWF) layer comprising carbon fibers, and wherein applying the conductive layer over the composite scarf repair patch and at least the area of the composite structure surrounding the composite scarf repair patch comprises applying the conductive layer to directly contact at least a portion of the outer layer surrounding the composite scarf repair patch to create a conductive bridge for the outer layer over the composite scarf repair patch.

20. A repair patch for electromagnetic effects (EME) protection of a composite structure, comprising:
a composite repair patch or a composite scarf repair patch sized to correspond to a repair area of a composite structure; and
a conductive layer disposed on the composite repair patch or the composite scarf repair patch,
wherein the conductive layer has a size larger than the composite repair patch or the composite scarf repair patch,
wherein the conductive layer is configured to overlap the composite repair patch or the composite scarf repair patch when disposed on the composite structure, and
wherein the conductive layer comprises a metal or metal alloy and the conductive layer is configured to create a conductive bridge over the composite repair patch or the composite scarf repair patch.
